(19) United States
(12) Patent Application Publication
(10) Pub. No.: US 2025/0274835 A1
(43) Pub. Date: Aug. 28, 2025

(54) METHOD AND APPARATUS FOR SUPPORT LOCATION INFORMATION COLLECTION

(71) Applicant: Samsung Electronics Co., Ltd., Gyeonggi-do (KR)

(72) Inventors: Yanru WANG, Beijing (CN); Hong WANG, Beijing (CN); Lixiang XU, Beijing (CN); Weiwei WANG, Beijing (CN)

(21) Appl. No.: 18/858,484

(22) PCT Filed: Apr. 24, 2023
(86) PCT No.: PCT/KR2023/005517

§ 371 Date: Oct. 21, 2024

(30) Foreign Application Priority Data
Apr. 22, 2022 (CN) 202210430973.3
Sep. 26, 2022 (CN) 202211177352.5
Mar. 30, 2023 (CN) 202310332730.0

(51) Int. Cl. H04W 36/32; H04W 36/08

(52) U.S. Cl. CPC H04W 36/324; H04W 36/08

(57) ABSTRACT

The disclosure relates to a 5G or 6G communication system for supporting a higher data transmission rate. The present disclosure provides a method and apparatus for support location information collection. A method performed by a first entity in a wireless communication system according to embodiments of the present disclosure may include: receiving, from a second entity, at least one of location information, location information status and capability information of the second entity, wherein the location information and the location information status are associated with at least one of the second entity and an other entity. The methods provided by the present disclosure can enable the first entity to accurately identify the type of location information, accurately obtain the required location information, and efficiently obtain the location information of the second entity and/or an other entity, and reduce unnecessary information interpretation by the first entity.

### TECHNICAL FIELD

The present disclosure relates to a technical field of wireless communication, and more particularly, the present disclosure relates to support location information for an entity in a wireless communication system and a method performed by the same.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

The present invention has been made to address at least the above problems and/or disadvantages and to provide at least the advantages described below. Accordingly, an aspect of the present invention provides a method and apparatus for support location information collection.

### Solution to Problem

Embodiments of the present disclosure provide a method performed by a first entity in a wireless communication system, including: receiving, from a second entity, at least one of location information, location information status and capability information of the second entity, wherein the location information and the location information status are associated with at least one of the second entity and an other entity.

Embodiments of the present disclosure provide a method performed by a second entity in a wireless communication system, including: transmitting, to a first entity, at least one of location information, location information status and capability information of the second entity, wherein the location information and the location information status are associated with at least one of the second entity and an other entity.

Embodiments of the present disclosure provide a first entity in a wireless communication system, including: a transceiver configured to transmit and receive signals; and a processor coupled to the transceiver and configured to perform methods performed by the first entity in the wireless communication system according to embodiments of the present disclosure.

Embodiments of the present disclosure provide a second entity in a wireless communication system, including: a transceiver configured to transmit and receive signals; and a processor coupled to the transceiver and configured to perform methods performed by the second entity in the wireless communication system according to embodiments of the present disclosure.

Embodiments of the present disclosure provide a computer-readable medium having stored thereon computer-readable instructions which, when executed by a processor, implement methods performed by a first entity and/or a second entity in a wireless communication system according to embodiments of the present disclosure.

The methods performed by a first entity and/or a second entity in a wireless communication system provided by the present disclosure can enable the first entity to accurately identify the type of location information, accurately obtain the required location information, and efficiently obtain the location information of the second entity and/or an other entity, and reduce unnecessary information interpretation by the first entity.

### Advantageous Effects of Invention

Advantages, and salient features of the invention will become apparent to those skilled in the art from the following detailed description, which, taken in conjunction with the annexed drawings, discloses exemplary embodiments of the invention. For more enhanced communication system, there is a need for a method and apparatus for support location information collection.

### BRIEF DESCRIPTION OF DRAWINGS

The above and other aspects, features and advantages of certain embodiments of the present disclosure will be more apparent from the following description taken in conjunction with the accompanying drawings, in which:

FIG. 1 is an exemplary system architecture 100 of System Architecture Evolution (SAE);

FIG. 2 is an exemplary system architecture 200 according to various embodiments of the present disclosure;

FIG. 3 illustrates a flowchart of a method 300 performed by a first entity in a wireless communication system according to embodiments of the present disclosure;

FIG. 4 illustrates a flowchart of a method 400 performed by a second entity in a wireless communication system according to embodiments of the present disclosure;

FIG. 5 illustrates a schematic diagram of one aspect of a method of supporting location information collection according to embodiments of the present disclosure;

FIG. 6 illustrates a schematic diagram of one aspect of a method of supporting location information collection according to embodiments of the present disclosure;

FIG. 7 illustrates a schematic diagram of one aspect of a method of supporting location information collection according to embodiments of the present disclosure;

FIG. 8 illustrates a schematic diagram of one aspect of a method of supporting location information collection according to embodiments of the present disclosure;

FIG. 9 illustrates a schematic diagram of one aspect of a method of supporting location information collection according to embodiments of the present disclosure;

FIG. 10 illustrates a schematic diagram of one aspect of a method of supporting location information collection according to embodiments of the present disclosure;

FIG. 11 illustrates a schematic diagram of one aspect of a method of supporting location information collection according to embodiments of the present disclosure;

FIG. 12 illustrates a schematic diagram of one aspect of a method of supporting location information collection according to embodiments of the present disclosure;

FIG. 12A illustrates a schematic diagram of one aspect of a method of supporting location information collection according to embodiments of the present disclosure;

FIG. 12B illustrates a schematic diagram of one aspect of a method of supporting location information collection according to embodiments of the present disclosure;

FIG. 12C illustrates a schematic diagram of one aspect of a method of supporting location information collection according to embodiments of the present disclosure;

FIG. 12D illustrates a schematic diagram of one aspect of a method of supporting location information collection according to embodiments of the present disclosure;

FIG. 12E illustrates a schematic diagram of one aspect of a method of supporting location information collection according to embodiments of the present disclosure;

FIG. 13 illustrates a schematic diagram of a first entity 1300 according to embodiments of the present disclosure; and

FIG. 14 illustrates a schematic diagram of a second entity 1400 according to embodiments of the present disclosure.

### MODE FOR THE INVENTION

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

The following specification particularly describes and ascertains the nature of this invention and the manner in which it is to be performed:

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “contain”, “include” or “may include” refers to the existence of a corresponding disclosed function, operation or component which can be used in various embodiments of the present disclosure and does not limit one or more additional functions, operations, or components. The terms such as “contain”, “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

Embodiments of the present disclosure provide a method performed by a first entity in a wireless communication system, including: receiving, from a second entity, at least one of location information, location information status and capability information of the second entity, wherein the location information and the location information status are associated with at least one of the second entity and an other entity.

According to embodiments of the present disclosure, the method further includes: transmitting first information including a location information collection configuration to the second entity, wherein the location information is based on the location information collection configuration.

According to embodiments of the present disclosure, the method further includes: transmitting second information including at least one of a location information reporting configuration and a location information reporting request to the second entity, wherein the location information is transmitted by the second entity to the first entity based on at least one of the location information reporting configuration and the location information reporting request.

According to embodiments of the present disclosure, the method further includes: determining at least one of a location information collection configuration, a location information reporting configuration and a location information reporting request for collecting and/or reporting the location information based on the capability information.

According to embodiments of the present disclosure, the method further includes: transmitting fifth information for capability negotiation to the second entity, wherein the capability information is transmitted by the second entity to the first entity based on the fifth information.

According to embodiments of the present disclosure, the location information is used for the first entity to make at least one of trajectory prediction and network self-optimization decision, wherein the network self-optimization decision includes at least one of network energy saving, load balancing, coverage optimization, mobility optimization and management.

According to embodiments of the present disclosure, the first information includes one or more of the following: Location Information Collection Time, Location Information Collection Content, Location Information Collection Scope, Same Location Merging Indication, Location Information Recording Threshold, Location Information Recording Time Interval, Location Information Recording Times, Location Information Reporting Interval, Location Information Acquisition Way, RAN-side Configuration Indication, Measurement Identification, Incremental Configuration Indication, Location Information Only Indication, Continuous Measurement Indication, Continuous Measurement Upon State Transition Indication, Information of a Requesting and/or configuring Node and/or Cell, Node and/or Cell for Location information Reporting, Final Node and/or Cell for Location information Reporting, Trajectory Prediction Request Indication, Prediction Registration Request, Configured Prediction Time, Configured Prediction Result Reporting Type, Configured Prediction Result Reporting Period, Reporting Trigger Event, Configured Prediction Type, and Configured Content Required To Be Predicted.

According to embodiments of the present disclosure, the second information includes one or more of the following: Location Information Reporting Indication, Location Information Reporting Time, Location Information Collection Time That Required For Reporting, Location Information Collection Scope That Required For Reporting, Location Information Reporting Content, Indication of Merging Same Location Upon Reporting, Location Information Recording Threshold For Reporting, Location Information Recording Time Interval For Reporting, Location Information Recording Times That Required For Reporting, Location Information Reporting Interval, Acquisition Way of Location Information That Required For Reporting, Reporting Indication of a Report Corresponding To a RAN-side Configuration, Measurement Identification That Required For Reporting, Reporting Indication of a Report Corresponding To an Incremental Configuration, Only Location Information Reporting Indication, Reporting Indication of a Report Corresponding To a Continuous Measurement, Reporting Indication of a Report Corresponding To a Continuous Measurement Upon State Transition, Reporting Indication of MDT Report, MDT Available Query, Indication of Whether The Reporting Needs To Include Connected-State Measurement Result, Collection Scope of Connected-State Measurement Result That Required For Reporting, Information of a Requesting and/or configuring Node and/or Cell, Node and/or Cell for Location information Reporting, Final Node and/or Cell for Location information Reporting, Trajectory Prediction Reporting Indication, Only Trajectory Prediction Reporting Indication, Registration Request For Prediction Result Reporting, Prediction Time of Prediction Result That Required For Reporting, Required Prediction Result Reporting Type, Required Prediction Result Reporting Period, Reporting Trigger Event, Type of Prediction Result That Required For Reporting, and Prediction Content That Required For Reporting.

According to embodiments of the present disclosure, the location information status is included in third information, wherein the third information includes one or more of the following: Location Information Available Indication, Measurement Identification Corresponding To Available Report, Indication of RAN-side Configuration Related Report Available, Indication of Incremental Configuration Related Report Available, Only Location Information Available Indication, Continuous Measurement Result Available Indication, Continuous Measurement Result Upon State Transition Available Indication, Connected-State Measurement Result Available Indication, MDT Report Available Indication, Trajectory Prediction Result Available Indication, and Available Location Information Acquisition Way, Information of a Requesting and/or configuring Node and/or Cell, Node and/or Cell for Location information Reporting, Final Node and/or Cell for Location information Reporting.

According to embodiments of the present disclosure, the location information is included in fourth information, wherein the fourth information includes one or more of the following: Location Information, Time Corresponding To Location Information, Identification of Entity To Which Location Information Belongs, Indication of Including Location Information, Indication of Same Location Merging To Display, Duration of Same Location, Measurement Identification, Indication of Report Corresponding To RAN-side Configuration, Indication of Report Corresponding To Incremental Configuration, Indication of Location Information Only, Indication of Including Continuous Measurement Result, Indication of Including Continuous Measurement Result Upon State Transition, Indication of Including Connected-State Measurement Result, MDT Report Indication, MDT Report, Indication of Including Trajectory Prediction Result, Prediction Content Prediction Identification, Indication of Obtaining Location Information By Prediction, Indication of Obtaining Location Information By Artificial Intelligence and/or Machine Learning Model, Requested Content Confirmation, Prediction Time, Predicted Type, Predicted Content, Reporting Trigger Event, Information of a Requesting and/or configuring Node and/or Cell, Node and/or Cell for Location information Reporting, Final Node and/or Cell for Location information Reporting, and Information For Cause Of Trajectory Prediction Request Failure.

According to embodiments of the present disclosure, the fifth information includes one or more of the following: Request for Information Reporting Consent, Request for Information Collection Interval, Candidate Interval for Information Collection, Request for Information Collection Times, Candidate Times for Information Collection, Request for Prediction Capability, Request for Prediction Content, Request for Prediction Interval, Candidate Prediction Interval, Request for Prediction Times, Candidate Prediction Times, Request for Interval Applicable and/or Valid To Prediction Result, and Candidate Interval Applicable and/or Valid To Prediction Result.

According to embodiments of the present disclosure, the capability information is included in sixth information, wherein the sixth information includes one or more of the following: Information Reporting Consent, Acceptable Information Content To Be Collected, Acceptable Information Content To Be Reported, Acceptable Information Collection Interval, Acceptable Information Collection Times, Prediction Capability Reporting, Predictable Content, Acceptable Prediction Interval, Acceptable Prediction Times, and Acceptable Interval Applicable and/or Valid To Prediction Result.

According to embodiments of the present disclosure, the capability information is associated with at least one of the following: location information, traffic information, user experience information, quality of service information, privacy information, and capability for prediction, wherein the prediction includes at least one of the following: trajectory prediction, traffic prediction, user experience prediction, quality of service prediction, and privacy data prediction.

Embodiments of the present disclosure provide a method performed by a second entity in a wireless communication system, including: transmitting, to a first entity, at least one of location information, location information status and capability information of the second entity, wherein the location information and the location information status are associated with at least one of the second entity and an other entity.

According to embodiments of the present disclosure, the method further includes: receiving first information including a location information collection configuration from the first entity, wherein the location information is based on the location information collection configuration.

According to embodiments of the present disclosure, the method further includes: receiving second information including at least one of a location information reporting configuration and a location information reporting request from the first entity, wherein transmitting the location information to the first entity includes transmitting the location information to the first entity based on at least one of the location information reporting configuration and the location information reporting request.

According to embodiments of the present disclosure, at least one of a location information collection configuration, a location information reporting configuration and a location information reporting request for collecting and/or reporting the location information is determined based on the capability information.

According to embodiments of the present disclosure, the method further includes: receiving fifth information for capability negotiation from the first entity, wherein transmitting the capability information to the first entity includes transmitting the capability information to the first entity based on the fifth information.

According to embodiments of the present disclosure, the location information is used for the first entity to make at least one of trajectory prediction and network self-optimization decision, wherein the network self-optimization decision includes at least one of network energy saving, load balancing, coverage optimization, mobility optimization and management.

According to embodiments of the present disclosure, the first information includes one or more of the following: Location Information Collection Time, Location Information Collection Content, Location Information Collection Scope, Same Location Merging Indication, Location Information Recording Threshold, Location Information Recording Time Interval, Location Information Recording Times, Location Information Reporting Interval, Location Information Acquisition Way, RAN-side Configuration Indication, Measurement Identification, Incremental Configuration Indication, Location Information Only Indication, Continuous Measurement Indication, Continuous Measurement Upon State Transition Indication, Information of a Requesting and/or configuring Node and/or Cell, Node and/or Cell for Location information Reporting, Final Node and/or Cell for Location information Reporting, Trajectory Prediction Request Indication, Prediction Registration Request, Configured Prediction Time, Configured Prediction Result Reporting Type, Configured Prediction Result Reporting Period, Reporting Trigger Event, Configured Prediction Type, and Configured Content Required To Be Predicted.

According to embodiments of the present disclosure, the second information includes one or more of the following: Location Information Reporting Indication, Location Information Reporting Time, Location Information Collection Time That Required For Reporting, Location Information Collection Scope That Required For Reporting, Location Information Collection Scope That Required For Reporting, Indication of Merging Same Location Upon Reporting, Location Information Recording Threshold For Reporting, Location Information Recording Time Interval For Reporting, Location Information Recording Times That Required For Reporting, Location Information Reporting Interval, Acquisition Way of Location Information That Required For Reporting, Reporting Indication of a Report Corresponding To a RAN-side Configuration, Measurement Identification That Required For Reporting, Reporting Indication of a Report Corresponding To an Incremental Configuration, Only Location Information Reporting Indication, Reporting Indication of a Report Corresponding To a Continuous Measurement, Reporting Indication of a Report Corresponding To a Continuous Measurement Upon State Transition, Reporting Indication of MDT Report, MDT Available Query, Indication of Whether The Reporting Needs To Include Connected-State Measurement Result, Collection Scope of Connected-State Measurement Result That Required For Reporting, Information of a Requesting and/or configuring Node and/or Cell, Node and/or Cell for Location information Reporting, Final Node and/or Cell for Location information Reporting, Trajectory Prediction Reporting Indication, Only Trajectory Prediction Reporting Indication, Registration Request For Prediction Result Reporting, Prediction Time of Prediction Result That Required For Reporting, Required Prediction Result Reporting Type, Required Prediction Result Reporting Period, Reporting Trigger Event, Type of Prediction Result That Required For Reporting, and Prediction Content That Required For Reporting.

According to embodiments of the present disclosure, the location information status is included in third information, wherein the third information includes one or more of the following: Location Information Available Indication, Measurement Identification Corresponding To Available Report, Indication of RAN-side Configuration Related Report Available, Indication of Incremental Configuration Related Report Available, Only Location Information Available Indication, Continuous Measurement Result Available Indication, Continuous Measurement Result Upon State Transition Available Indication, Connected-State Measurement Result Available Indication, MDT Report Available Indication, Trajectory Prediction Result Available Indication, and Available Location Information Acquisition Way, Information of a Requesting and/or configuring Node and/or Cell, Node and/or Cell for Location information Reporting, Final Node and/or Cell for Location information Reporting.

According to embodiments of the present disclosure, the location information is included in fourth information, wherein the fourth information includes one or more of the following: Location Information, Time Corresponding To Location Information, Identification of Entity To Which Location Information Belongs, Indication of Including Location Information, Indication of Same Location Merging To Display, Duration of Same Location, Measurement Identification, Indication of Report Corresponding To RAN-side Configuration, Indication of Report Corresponding To Incremental Configuration, Indication of Location Information Only, Indication of Including Continuous Measurement Result, Indication of Including Continuous Measurement Result Upon State Transition, Indication of Including Connected-State Measurement Result, MDT Report Indication, MDT Report, Indication of Including Trajectory Prediction Result, Prediction Content Prediction Identification, Indication of Obtaining Location Information By Prediction, Indication of Obtaining Location Information By Artificial Intelligence and/or Machine Learning Model, Requested Content Confirmation, Prediction Time, Predicted Type, Predicted Content, Reporting Trigger Event, Information of a Requesting and/or configuring Node and/or Cell, Node and/or Cell for Location information Reporting, Final Node and/or Cell for Location information Reporting, and Information For Cause Of Trajectory Prediction Request Failure.

According to embodiments of the present disclosure, the fifth information includes one or more of the following: Request for Information Reporting Consent, Request for Information Collection Interval, Candidate Interval for Information Collection, Request for Information Collection Times, Candidate Times for Information Collection, Request for Prediction Capability, Request for Prediction Content, Request for Prediction Interval, Candidate Prediction Interval, Request for Prediction Times, Candidate Prediction Times, Request for Interval Applicable and/or Valid To Prediction Result, and Candidate Interval Applicable and/or Valid To Prediction Result.

According to embodiments of the present disclosure, the capability information is included in sixth information, wherein the sixth information includes one or more of the following: Information Reporting Consent, Acceptable Information Content To Be Collected, Acceptable Information Content To Be Reported, Acceptable Information Collection Interval, Acceptable Information Collection Times, Prediction Capability Reporting, Predictable Content, Acceptable Prediction Interval, Acceptable Prediction Times, and Acceptable Interval Applicable and/or Valid To Prediction Result.

According to embodiments of the present disclosure, the capability information is associated with at least one of the following: location information, traffic information, user experience information, quality of service information, privacy information, and capability for prediction, wherein the prediction includes at least one of the following: trajectory prediction, traffic prediction, user experience prediction, quality of service prediction, and privacy data prediction. Embodiments of the present disclosure provide a first entity in a wireless communication system, including: a transceiver configured to transmit and receive signals; and a controller coupled to the transceiver and configured to perform methods performed by the first entity in the wireless communication system according to embodiments of the present disclosure.

Embodiments of the present disclosure provide a second entity in a wireless communication system, including: a transceiver configured to transmit and receive signals; and a controller coupled to the transceiver and configured to perform methods performed by the second entity in the wireless communication system according to embodiments of the present disclosure.

Embodiments of the present disclosure provide a computer-readable medium having stored thereon computer-readable instructions which, when executed by a processor, implement methods performed by a first entity and/or a second entity in a wireless communication system according to embodiments of the present disclosure.

The methods performed by a first entity and/or a second entity in a wireless communication system provided by the present disclosure can enable the first entity to accurately identify the type of location information, accurately obtain the required location information, and efficiently obtain the location information of the second entity and/or an other entity, and reduce unnecessary information interpretation by the first entity.

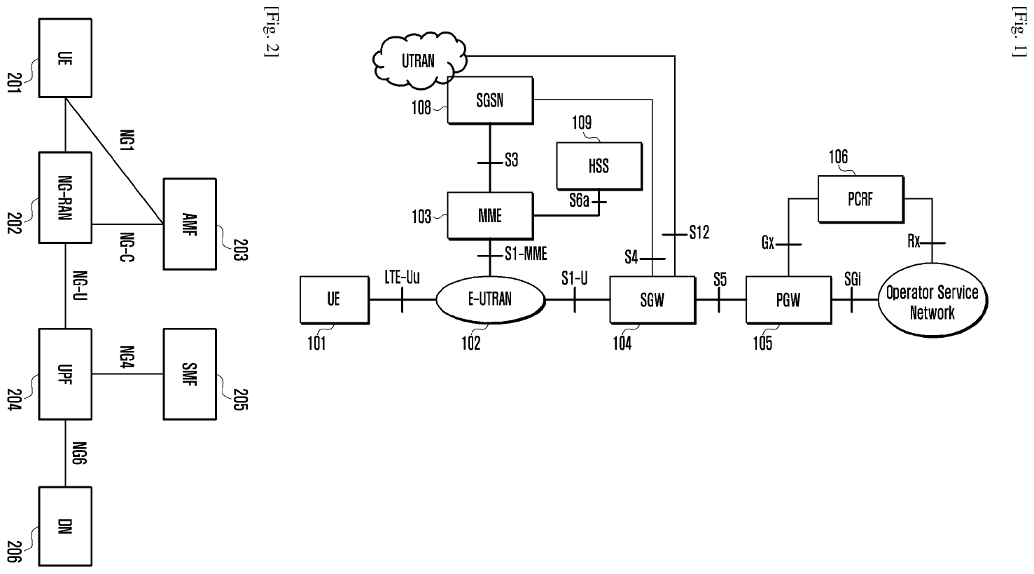

FIGS. 1 to 14 discussed below and various embodiments for describing the principles of the present disclosure in this patent document are only for illustration and should not be interpreted as limiting the scope of the present disclosure in any way. Those skilled in the art will understand that the principles of the present disclosure can be implemented in any suitably arranged system or device.

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QOS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

FIG. 2 is an exemplary system architecture 200 according to various embodiments of the present disclosure. Other embodiments of the system architecture 200 can be used without departing from the scope of the present disclosure.

User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

Entities and/or nodes described in the present disclosure may include: gNB, gNB Central Unit (gNB CU), gNB Distributed Unit (gNB DU), gNB-CU-Control Plane (gNB CU-CP), gNB-CU-User Plane (gNB CU-UP), en-gNB, eNB, ng-eNB, UE, Access and Mobility Management Function (AMF), Session Management Function (SMF), Mobility Management Entity (MME) and other network entities or network logic units.

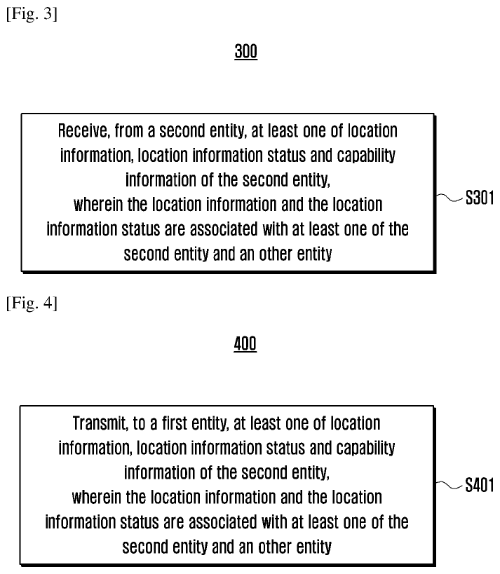

FIG. 3 illustrates a flowchart of a method 300 performed by a first entity in a wireless communication system according to embodiments of the present disclosure.

As shown in FIG. 3, in step S301, the method 300 performed by the first entity in the wireless communication system according to embodiments of the present disclosure may include: receiving, from a second entity, at least one of location information, location information status and capability information of the second entity. In some implementations, the location information and the location information status may be associated with at least one of the second entity and an other entity. For example, the location information may be location information of the second entity or location information of any other entity. Here, the other entity may be any entities except the second entity, and the first entity, the second entity and the other entity may be any network entities as described above.

In some implementations, the method 300 may further include: transmitting first information including a location information collection configuration to the second entity. In some implementations, the location information received from the second entity may be collected by the second entity based on the location information collection configuration. In some implementations, the location information may also be collected by the second entity based on a location information collection configuration from any other entity except the first entity, or based on its own capability or configuration.

In some implementations, the method 300 may further include: transmitting second information including at least one of a location information reporting configuration and a location information reporting request to the second entity. In some implementations, the location information may be transmitted by the second entity to the first entity based on at least one of the location information reporting configuration and the location information reporting request. In some implementations, the location information may also be transmitted by the second entity to the first entity based on other configurations or requests from the first entity or an other entity, or autonomously.

In some implementations, the first entity may determine at least one of a location information collection configuration, a location information reporting configuration and a location information reporting request for collecting and/or reporting the location information based on the capability information of the second entity.

In some implementations, the method 300 may further include: transmitting fifth information for capability negotiation to the second entity. In some implementations, the capability information may be transmitted by the second entity to the first entity based on the fifth information. In some implementations, the capability information of the second entity may also be transmitted by the second entity to the first entity based on other configurations or autonomously.

FIG. 4 illustrates a flowchart of a method 400 performed by a second entity in a wireless communication system according to embodiments of the present disclosure.

As shown in FIG. 4, in step S401, the method 400 performed by the second entity in the wireless communication system according to embodiments of the present disclosure may include: transmitting, to a first entity, at least one of location information, location information status and capability information of the second entity. In some implementations, the location information and the location information status may be associated with at least one of the second entity and an other entity. For example, the location information may be location information of the second entity or location information of any other entity. Here, the other entity may be any entities except the second entity, and the first entity, the second entity and the other entity may be any network entities as described above.

In some implementations, the method 400 may further include: receiving first information including a location information collection configuration from the first entity; and collecting the location information of the second entity and/or an other entity based on the location information collection configuration received from the first entity. In some implementations, the location information may also be collected by the second entity based on a location information collection configuration from any other entity except the first entity, or based on its own capability or configuration.

In some implementations, the method 400 may further include: receiving second information including at least one of a location information reporting configuration and a location information reporting request from the first entity. In some implementations, transmitting the location information to the first entity may include transmitting the location information to the first entity based on at least one of the location information reporting configuration and the location information reporting request received from the first entity. In some implementations, the location information may also be transmitted by the second entity to the first entity based on other configurations or requests from the first entity or an other entity, or autonomously.

In some implementations, the method 400 may further include: receiving fifth information for capability negotiation from the first entity. In some implementations, transmitting the capability information to the first entity may include transmitting the capability information to the first entity based on the fifth information. In some implementations, the capability information of the second entity may also be transmitted by the second entity to the first entity based on other configurations or autonomously.

The methods performed by the first entity and/or the second entity in the wireless communication system according to embodiments of the present disclosure will be further described below with specific examples.

In some embodiments, a method for supporting location information collection according to embodiments of the present disclosure may include: a first entity transmits first information including a location information collection configuration to a second entity, so that the second entity may collect location information of the second entity and/or an other entity according to the location information collection configuration, and feed back the location information to the first entity, in order for the first entity to efficiently obtain the required location information of the second entity and/or the other entity, so as to reduce unnecessary location information collection, storage and the like. In addition, the second entity may be configured to collect continuous location information, thus avoiding information loss in a certain period. The location information may be used for the first entity to perform model training and/or inference for trajectory prediction, and/or make network self-optimization decision, etc.

The first information may be included in one or more of the following: LoggedMeasurementConfiguration, reportConfigNR, and EventTriggerConfig and/or PeriodicalReportConfig in LoggedMeasurementConfiguration and/or reportConfigNR of Radio Resource Control (RRC); RETRIEVE UE CONTEXT RESPONSE message, PARTIAL UE CONTEXT TRANSFER message, XN SETUP REQUEST message, XN SETUP RESPONSE message, NG-RAN NODE CONFIGURATION UPDATE message, and NG-RAN NODE CONFIGURATION UPDATE ACKNOWLEDGE message of Xn; F1 SETUP REQUEST message, F1 SETUP RESPONSE message, GNB-DU CONFIGURATION UPDATE message, GNB-DU CONFIGURATION UPDATE ACKNOWLEDGE message, GNB-CU CONFIGURATION UPDATE message, and GNB-CU CONFIGURATION UPDATE ACKNOWLEDGE message of F1; GNB-CU-UP E1 SETUP REQUEST message, GNB-CU-UP E1 SETUP RESPONSE message, GNB-CU-CP E1 SETUP REQUEST message, GNB-CU-CP E1 SETUP RESPONSE message, GNB-CU-UP CONFIGURATION UPDATE message, GNB-CU-UP CONFIGURATION UPDATE ACKNOWLEDGE message, GNBCU-CP CONFIGURATION UPDATE message, and GNB-CU-CP CONFIGURATION UPDATE ACKNOWLEDGE of E1; or one other and/or newly defined RRC and/or Xn and/or X2 and/or F1 and/or E1 and/or NG message.

In some implementations, the first information may include one or more of the following:
Location Information Collection Time: used to indicate the time when location information needs to be collected. The collection time may include: before a certain time point, after a certain time point, a time interval, a time point, a period of time before a certain event, a period of time after a certain event, a time point before a certain event, and a time point after a certain event, etc. Herein, a certain event may include one or more of the following: RRC state switches to a RRC Connected state, RRC state switches to a RRC Idle state and/or Inactive state, switching among Idle, Inactive and Connected states, accessing and/or leaving a cell, accessing and/or leaving an operator, accessing and/or leaving a slice, etc. The time may be represented by 2*n bits, for example, the first n bits represent a start time for collection, and the last n bits represent an end time for collection. The time may be either a relative time or an absolute time. It may also be represented by separate fields, including one or more of the following:
   Collection Start Time: used to indicate a start time for collection. The start time may be either a relative time or an absolute time.
   Collection End Time: used to indicate an end time for collection. The end time may be either a relative time or an absolute time.
Location Information Collection Content: used to indicate location information required to be collected. The collection content may also be a granularity of the location information required to be collected. The location information may be an absolute location, a relative location, etc. The location information may be expressed by latitude and longitude, absolute coordinates, relative coordinates, serving cell, camping cell, etc. The location information may include one or more of the following: time point and/or time interval, location coordinates, estimated speed (including magnitude and/or direction), cell identification (such as Cell Global ID, etc.), entity identification, beam identification, accuracy, etc. The serving cell and/or the camping cell may be represented by a cell identification. The granularity may include one or more of the following: accuracy of location information, cell level, entity level, beam level, coordinate level, etc. The accuracy of location information may include, for example, meter, centimeter, decimeter, kilometer, etc.
Location Information Collection Scope: used to indicate a collection scope where location information of an entity needs to be collected only when the entity is in the collection scope and/or when the entity belongs to the collection scope. The collection scope may include geographic location scope, slice identification (such as Single Network Slice Selection Assistance Information (S-NSSAI)) and/or slice identification list (such as S-NSSAI list), cell identification and/or cell identification list, operator identification (such as Public Land Mobile Network (PLMN)) and/or operator identification list (such as PLMN list), beam identification and/or beam identification list, etc. The collection scope may also be an entity identification and/or an entity identification list.
Same Location Merging Indication: used to indicate that if the location information is the same in a continuous period of time, the location information in that period of time may be merged into one piece.
Location Information Recording Threshold: used to indicate a threshold at which the location information needs to be recorded when a status of the location information exceeds the threshold. The threshold may be a time value, a distance, etc. If the threshold is a time value, in some implementations, it may be that the location information needs to be recorded when the entity stays in a certain location for more than and/or less than and/or more than or equal to and/or less than or equal to the threshold time value. If the threshold value is a distance, in some implementations, it may be that the current location information needs to be recorded when the distance between the current location and the last recorded location is greater than and/or less than and/or greater than or equal to and/or less than or equal to the threshold distance.
Location Information Recording Time Interval: used to indicate a time interval for recording location information.
Location Information Recording Times: used to indicate the number of times that location information needs to be recorded. The number of times may be the number of recording times in a reporting interval or the total number of times that need to be recorded.
Location Information Reporting Interval: used to indicate a time interval for reporting location information.
Location Information Acquisition Way: used to indicate an acquisition way of the location information required to be collected. The acquisition way may include one or more of the following: acquiring by using artificial intelligence and/or machine learning models, and acquiring by using a traditional way (such as Assisted Global Navigation Satellite System (A-GNSS), Observed Time Difference Of Arrival (OTDOA), Enhanced Cell-ID (E-CID), Sensor, Wireless Local Area Network (WLAN), Bluetooth, Terrestrial Beacon System (TBS), Downlink Time Difference Of Arrival (DL-TDOA), Downlink Angle-of-Departure (DL-AoD), Multi Round Trip Time (Multi-RTT), New Radio Enhanced Cell-ID (NR E-CID), Uplink Time Difference of Arrival (UL-TDOA), Uplink Angle of Arrival (UL-AoA), etc.).
RAN-side Configuration Indication: used to indicate that a configuration is from the Radio Access Network (RAN) side. This indication may be represented by a single bit. For example, when the field value is 1, it means that the configuration is from the RAN-side, and when the field value is 0, it means that the configuration is not from the RAN-side (for example, it may be from a core network, Operations, Administration and Maintenance (OAM) system, etc.); or when the field value is 1, it means that the configuration is not from the RAN-side (for example, it may be from a core network, OAM, etc.), and when the field value is 0, it means that the configuration is from the RAN-side.
Measurement Identification: used to identify a measurement.
Incremental Configuration Indication: used to indicate whether a configuration is an incremental configuration. If the configuration is an incremental configuration, the configuration does not cover the previous configuration information, and the configuration is effective at the same time as the previous configuration information. This indication may be represented by a single bit. For example, when the field value is 1, it means that the configuration is an incremental configuration, and when the field value is 0, it means that the configuration is not an incremental configuration; or when the field value is 1, it means that the configuration is not an incremental configuration, and when the field value is 0, it means that the configuration is an incremental configuration.
Location Information Only Indication: used to indicate whether only location information needs to be collected. If only the location information needs to be collected, no other information, such as signal measurement results, is needed. This indication may be represented by a single bit. For example, when the field value is 1, it means that only location information needs to be collected, and when the field value is 0, it means that other information also needs to be collected; or when the field value is 1, it means that other information also needs to be collected, and when the field value is 0, it means that only location information needs to be collected.
Continuous Measurement Indication: used to indicate whether an entity needs to continuously perform measurement before receiving a subsequent measurement configuration. This indication may be represented by a single bit. For example, when the field value is 1, it means that the entity needs to continuously perform measurement before receiving a subsequent measurement configuration, and when the field value is 0, it means that the entity may stop measurement under certain conditions, such as when it switches from an Idle and/or Inactive state to a Connected state, or when it switches from a Connected state to an Idle and/or Inactive state, or when it switches among Idle, Inactive and Connected states, or when it accesses and/or leaves a cell, or when it accesses and/or leaves an operator, or when it accesses and/or leaves a slice, or when it accesses and/or leaves a beam, or when it accesses and/or leaves an entity, or when it receives a further indication (for example, it may be a measurement stop indication, etc.), or when it receives a new configuration, or when a handover occurs, or when it receives predicted trajectory information, or when it receives predicted information, or when it receives artificial intelligence machine learning related information; or when the field value is 1, it means that the entity may stop measurement under certain conditions, such as when it switches from an Idle and/or Inactive state to a Connected state, or when it switches from a Connected state to an Idle and/or Inactive state, or when it switches among Idle, Inactive and Connected states, or when it accesses and/or leaves a cell, or when it accesses and/or leaves an operator, or when it accesses and/or leaves a slice, or when it accesses and/or leaves a beam, or when it accesses and/or leaves an entity, or when it receives a further indication (for example, it may be a measurement stop indication, etc.), or when it receives a new configuration, or when a handover occurs, or when it receives predicted trajectory information, or when it receives predicted information, or when it receives artificial intelligence machine learning related information, and when the field value is 0, it means that the entity needs to continuously perform measurement before receiving a subsequent measurement configuration.
Continuous Measurement Upon State Transition Indication: used to indicate whether an entity needs to continuously perform measurement upon state transition. This indication may be represented by a single bit. For example, when the field value is 1, it means that the entity needs to continuously perform measurement upon state transition, and when the field value is 0, it means that the entity stops measurement upon state transition. The state transition includes switching from an Idle and/or Inactive state to a Connected state, or switching from a Connected state to an Idle and/or Inactive state, or switching among Idle, Inactive and Connected states, or accessing and/or leaving a cell, or accessing and/or leaving an operator, or accessing and/or leaving a slice, or accessing and/or leaving a beam, or accessing and/or leaving an entity, or receiving a further indication (for example, it may be a measurement stop indication, etc.), or receiving a new configuration, or a handover occurs, or receiving predicted trajectory information, or receiving predicted information, or receiving artificial intelligence machine learning related information. Or when the field value is 1, it means that the entity stops measurement upon state transition. The state transition includes switching from an Idle and/or Inactive state to a Connected state, or switching from a Connected state to an Idle and/or Inactive state, or switching among Idle, Inactive and Connected states, or accessing and/or leaving a cell, or accessing and/or leaving an operator, or accessing and/or leaving a slice, or accessing and/or leaving a beam, or accessing and/or leaving an entity, or receiving a further indication (for example, it may be a measurement stop indication, etc.), or receiving a new configuration, or a handover occurs, or receiving predicted trajectory information, or receiving predicted information, or receiving artificial intelligence machine learning related information. Or when the field value is 0, it means that the entity needs to continuously perform measurement upon state transition.
Information of a Requesting and/or configuring Node and/or Cell: information of a node and/or cell that requests and/or configures the reporting and/or collection, and/or information of a node and/or cell to which location information needs to be transmitted. It may be a node identification or a cell identification. It is used to inform the node and/or cell to which the collected location information should be transmitted.
Node and/or Cell for Location information Reporting: used to inform information of a node and/or cell to which location information needs to be reported. It may be a node identification or a cell identification. It is used to inform the node and/or cell to which the collected location information should be transmitted.
Final Node and/or Cell for Location information Reporting: used to inform information of a node and/or cell to which location information needs to be reported finally. It may be a node identification or a cell identification. It is used to inform the node and/or cell to which the collected location information should be transmitted finally. After an entity receiving the information, if the entity is not a final node and/or cell for location information reporting, it needs to subsequently forward the collection and/or reception to the final node and/or cell for location information reporting, or to other nodes to finally reach the final node and/or cell for location information reporting.

In some implementations, the first information may also include a trajectory prediction configuration. The trajectory prediction configuration may include one or more of the following:
Trajectory Prediction Request Indication: used to indicate whether an entity needs to perform trajectory prediction. This indication may be represented by a single bit. For example, when the field value is 1, it means that trajectory prediction is required, and when the field value is 0, it means that trajectory prediction is not required; or when the field value is 1, it means that trajectory prediction is not required, and when the field value is 0, it means that trajectory prediction is required.
Prediction Registration Request: used to indicate related information of at least one of the start, end or addition of a trajectory prediction request.
Configured Prediction Time: used to indicate related information of a configured time interval and/or time point required for trajectory prediction. The predicted time may also be a period of time before and/or after a certain event occurs. A certain event may be a change of RRC state, for example, including switching from an Idle and/or Inactive state to a Connected state, or switching from a Connected state to an Idle and/or Inactive state, or switching among Idle, Inactive and Connected states, or accessing and/or leaving a cell, or accessing and/or leaving an operator, or accessing and/or leaving a slice, or accessing and/or leaving a beam, or accessing and/or leaving an entity, or having an other indication (for example, the other indication may be a Trajectory Prediction Request Indication), or a handover occurs, or receiving predicted trajectory information, or receiving predicted information, or receiving artificial intelligence machine learning related information, etc.

The time interval may be for example represented by 2*n bits, for example, the first n bits represent a start time of trajectory prediction, and the last n bits represent an end time of trajectory prediction. The time may be either a relative time or an absolute time.

The time interval requested for prediction may also be represented by separate fields, for example, and may include one or more of the following:
Prediction Start Time: used to indicate a start time of trajectory prediction. The prediction start time may be, for example, a relative time or an absolute time.
Prediction End Time: used to indicate an end time of trajectory prediction. The predicted end time may be, for example, a relative time or an absolute time.
Configured Prediction Result Reporting Type: used to indicate whether the configured trajectory prediction result reporting is single reporting or periodic reporting. The prediction result reporting type may include, for example, but not limited to, on-demand type, periodic type, event-triggering type, etc.
Configured Prediction Result Reporting Period: used to indicate related information of a corresponding interval time when the configured prediction result reporting is periodic reporting. The reporting period may also be the prediction time of the reported data. If there is no content about this field, it means that single reporting is applicable, and the prediction time of the single reporting is from the prediction start time to the prediction end time.
Reporting Trigger Event: used to indicate related information of trigger conditions for reporting. Only when a prediction result or an actual situation meets the reporting trigger condition, reporting is needed. For example, if long-term camping, short-term camping, ping-pong movement, or RRC state change (for example, including switching from an Idle and/or Inactive state to a Connected state, or switching from a Connected state to an Idle and/or Inactive state, or switching among Idle, Inactive and Connected states, or accessing and/or leaving a cell, or accessing and/or leaving an operator, or accessing and/or leaving a slice, or accessing and/or leaving a beam, or accessing and/or leaving an entity, or having an other indication (for example, the other indication may be a Location Information Reporting Indication), or a handover occurs, or receiving predicted trajectory information, or receiving predicted information, or receiving artificial intelligence machine learning related information, etc.) occurs, reporting is needed.
Configured Prediction Type: used to indicate related information of the configured type of trajectory prediction. The prediction type may include, for example, but not limited to, trajectory coordinate prediction, camping cell prediction, connected serving cell prediction, trajectory special situation prediction, beam prediction, entity prediction, etc.
Configured Content Required To Be Predicted: used to indicate related information of configured detailed parameters that are required for trajectory prediction. The parameters required be predicted may include, for example, but not limited to, time point and/or time interval, location coordinates, estimated speed (including magnitude and/or direction), cell identification (such as Cell Global ID), entity identification, beam identification, type of a trajectory special situation, coordinate and/or range of a trajectory special situation, prediction accuracy and/or reliability, etc.

Herein, the type of a trajectory special situation may include, but not limited to, longterm camping, short-term camping, ping-pong movement, etc.

Herein, the coordinate and/or range of a trajectory special situation indicates the location where the trajectory special situation occurs.

As an implementation, the prediction content may be related to the prediction type. For example, if the prediction type is camping cell prediction or connected serving cell prediction, the prediction content may include but not limited to time point and/or time interval, cell identification, prediction accuracy and/or reliability, etc. For another example, if the prediction type selects the trajectory coordinate prediction, the prediction content may include but not limited to time point and/or time interval, location coordinates, estimated speed (including magnitude and/or direction), prediction accuracy and/or reliability, etc. For another example, if the prediction type selects the type of a trajectory special situation, the prediction content may include but not limited to time point and/or time interval, type of a trajectory special situation, coordinate and/or range of a trajectory special situation, prediction accuracy and/or reliability, etc. For another example, if the prediction type selects the beam prediction, the prediction content may include but not limited to time point and/or time interval, beam identification, prediction accuracy and/or reliability. For another example, if the prediction type selects the entity prediction, the prediction content may include but not limited to time point and/or time interval, entity identification, prediction accuracy and/or reliability.

In some implementations, a first entity may transmit second information including a location information reporting configuration and/or request to a second entity, so that the second entity may report location information of the second entity and/or an other entity according to the location information reporting configuration and/or request, in order for the first entity to efficiently obtain the required location information of the second entity or the other entity, and to accurately inform the second entity of reporting requirements, thus reducing unnecessary location information reporting and improving reporting efficiency, etc. The location information may be used for the first entity to perform model training and/or inference for trajectory prediction, and/or make network self-optimization decision, etc.

The second information may be included in one or more of the following: logMeasReportReq, UEInformationRequest, LoggedMeasurementConfiguration, reportConfigNR, and EventTriggerConfig and/or PeriodicalReportConfig in LoggedMeasurementConfiguration and/or reportConfigNR of RRC; RETRIEVE UE CONTEXT RESPONSE message, PARTIAL UE CONTEXT TRANSFER message, XN SETUP REQUEST message, XN SETUP RESPONSE message, NG-RAN NODE CONFIGURATION UPDATE message, and NG-RAN NODE CONFIGURATION UPDATE ACKNOWLEDGE message of Xn; F1 SETUP REQUEST message, F1 SETUP RESPONSE message, GNB-DU CONFIGURATION UPDATE message, GNB-DU CONFIGURATION UPDATE ACKNOWLEDGE message, GNB-CU CONFIGURATION UPDATE message, and GNB-CU CONFIGURATION UPDATE ACKNOWLEDGE message of F1; GNB-CU-UP E1 SETUP REQUEST message, GNB-CU-UP E1 SETUP RESPONSE message, GNB-CU-CP E1 SETUP REQUEST message, GNB-CU-CP E1 SETUP RESPONSE message, GNB-CU-UP CONFIGURATION UPDATE message, GNB-CU-UP CONFIGURATION UPDATE ACKNOWLEDGE message, GNB-CU-CP CONFIGURATION UPDATE message, and GNB-CU-CP CONFIGURATION UPDATE ACKNOWLEDGE of E1; or one other and/or newly defined RRC and/or Xn and/or X2 and/or F1 and/or E1 and/or NG message.

In some implementations, the second information may include one or more of the following:
Location Information Reporting Indication: used to indicate whether the second entity needs to report location information to the first entity. This indication may be represented by a single bit. For example, when the field value is 1, the location information needs to be reported, and when the field value is 0, the location information does not need to be reported; or when the field value is 1, the location information does not need to be reported, and when the field value is 0, the location information needs to be reported.
Location Information Reporting Time: used to indicate the time when location information needs to be reported. The reporting time may include: before a certain time point, after a certain time point, a time interval, a time point, a period of time before a certain event, a period of time after a certain event, a time point before a certain event, and a time point after a certain event, etc. Herein, a certain event may include: RRC state switches to a RRC Connected state, RRC state switches to a RRC Idle state and/or Inactive state, switching among Idle, Inactive and Connected states, accessing and/or leaving a cell, accessing and/or leaving an operator, accessing and/or leaving a slice, etc. The time may be represented by 2*n bits, for example, the first n bits represent a start time for reporting, and the last n bits represent an end time for reporting. The time may be either a relative time or an absolute time. It may also be represented by separate fields, including one or more of the following:
   Reporing Start Time: used to indicate a start time for reporting. The start time may be either a relative time or an absolute time.
   Reporing End Time: used to indicate an end time for reporting. The end time may be either a relative time or an absolute time.
Location Information Collection Time That Required For Reporting: used to indicate the time of collecting location information that is required to be reported. The collection time may be the same as or different from the actual collection time of the location information. For example, the collection time may be a part of the actual collection time of the location information. The collection time may include: before a certain time point, after a certain time point, a time interval, a time point, a period of time before a certain event, a period of time after a certain event, a time point before a certain event, and a time point after a certain event, etc. Herein, a certain event may include one or more of the following: RRC state switches to a RRC Connected state, RRC state switches to a RRC Idle state and/or Inactive state, accessing and/or leaving a cell, accessing and/or leaving an operator, accessing and/or leaving a slice, etc. The time may be represented by 2*n bits, for example, the first n bits represent a start time for collection, and the last n bits represent an end time for collection. The time may be either a relative time or an absolute time. It may also be represented by separate fields, including one or more of the following:
   Collection Start Time: used to indicate a start time for collection. The start time may be either a relative time or an absolute time.
   Collection End Time: used to indicate an end time for collection. The end time may be either a relative time or an absolute time.
Location Information Collection Scope That Required For Reporting: used to indicate a collection scope where location information of an entity needs to be reported only when the entity is in the collection scope and/or when the entity belongs to the collection scope. The collection scope may include geographic location scope, slice identification (such as S-NSSAI) and/or slice identification list (such as S-NSSAI list), cell identification and/or cell identification list, operator identification (such as PLMN) and/or operator identification list (such as PLMN list), beam identification and/or beam identification list, etc. The collection scope may also be an entity and/or an entity list.
Location Information Reporting Content: used to indicate location information required to be reported. The reporting content may also be a granularity of the location information required to be reported. The location information may be an absolute location, a relative location, etc. The location information may be expressed by latitude and longitude, absolute coordinates, relative coordinates, serving cell, camping cell, etc. The location information may include one or more of the following: time point and/or time interval, location coordinates, estimated speed (including magnitude and/or direction), cell identification (such as Cell Global ID, etc.), entity identification, beam identification, accuracy, etc. The serving cell and/or the camping cell may be represented by a cell identification. The granularity may include one or more of the following: accuracy of location information, cell level, entity level, beam level, coordinate level, etc. The accuracy of location information may include, for example, meter, centimeter, decimeter, kilometer, etc.
Indication of Merging Same Location Upon Reporting: used to indicate that if the location information is the same in a continuous period of time, the location information in that period may be merged into one piece for reporting.
Location Information Recording Threshold For Reporting: used to indicate a threshold at which the location information needs to be reported when a status of the location information exceeds the threshold. The threshold may be a time value, a distance, etc. If the threshold is a time value, in some implementations, it may be that the location information needs to be reported when the entity stays in a certain location for more than and/or less than and/or more than or equal to and/or less than or equal to the threshold time value. If the threshold value is a distance, in some implementations, it may be that the location information needs to be reported when the distance between the location and the location last recorded and/or required to be reported is greater than and/or less than and/or greater than or equal to and/or less than or equal to the threshold distance.
Location Information Recording Time Interval For Reporting: used to indicate a time interval for recording location information in the content that is required to be reported.
Location Information Recording Times That Required For Reporting: used to indicate the number of recording times of location information in the content that is required to be reported. The number of times may be the number of recording times in a reporting interval or the total number of times that need to be recorded.
Location Information Reporting Interval: used to indicate a time interval for reporting location information.
Acquisition Way of Location Information That Required For Reporting: used to indicate an acquisition way of location information that is required to be reported. The acquisition may may include one or more of the following: acquiring by using artificial intelligence and/or machine learning models, and acquiring by using a traditional way (such as Assisted Global Navigation Satellite System (A-GNSS), Observed Time Difference Of Arrival (OTDOA), Enhanced Cell-ID (E-CID), Sensor, Wireless Local Area Network (WLAN), Bluetooth, Terrestrial Beacon System (TBS), Downlink Time Difference Of Arrival (DL-TDOA), Downlink Angle-of-Departure (DL-AoD), Multi Round Trip Time (Multi-RTT), New Radio Enhanced Cell-ID (NR E-CID), Uplink Time Difference of Arrival (UL-TDOA), Uplink Angle of Arrival (UL-AoA), etc.).
Reporting Indication of a Report Corresponding To a RAN-side Configuration: used to indicate whether a report corresponding to a RAN-side configuration needs to be reported. This indication may be represented by a single bit. For example, when the field value is 1, it means that it needs to be reported, and when the field value is 0, it means that it does not need to be reported; or when the field value is 1, it means that it does not need to be reported, and when the field value is 0, it means that it needs to be reported.
Measurement Identification That Required For Reporting: used to identify a result corresponding to a measurement identification that is required to be reported.
Reporting Indication of a Report Corresponding To an Incremental Configuration: used to indicate whether a report corresponding to an incremental configuration needs to be reported. This indication may be represented by a single bit. For example, when the field value is 1, it means that it needs to be reported, and when the field value is 0, it means that it does not need to be reported; or when the field value is 1, it means that it does not need to be reported, and when the field value is 0, it means that it needs to be reported.
Only Location Information Reporting Indication: used to indicate whether only location information needs to be reported. This indication may be represented by a single bit. For example, when the field value is 1, only the location information needs to be reported, and when the field value is 0, other information also needs to be reported; or when the field value is 1, other information also needs to be reported, and when the field value is 0, only the location information needs to be reported.
Reporting Indication of a Report Corresponding To a Continuous Measurement: used to indicate whether a report corresponding to a continuous measurement stage needs to be reported. This indication may be represented by a single bit. For example, when the field value is 1, it means that it needs to be reported, and when the field value is 0, it means that it does not need to be reported; or when the field value is 1, it means that it does not need to be reported, and when the field value is 0, it means that it needs to be reported.
Reporting Indication of a Report Corresponding To a Continuous Measurement Upon State Transition: used to indicate whether a report corresponding to a continuous measurement upon state transition needs to be reported. This indication may be represented by a single bit. For example, when the field value is 1, it means that it needs to be reported, and when the field value is 0, it means that it does not need to be reported; or when the field value is 1, it means that it does not need to be reported, and when the field value is 0, it means that it needs to be reported.
Reporting Indication of MDT Report: used to indicate whether a second entity needs to report a MDT report to a first entity. This indication may be represented by a single bit. For example, when the field value is 1, the MDT report needs to be reported, and when the field value is 0, the MDT report does not need to be reported; or when the field value is 1, the MDT report does not need to be reported, and when the field value is 0, the MDT report needs to be reported. The MDT report includes Logged MDT Report and/or Immediate MDT Report.
MDT Available Query: used to query whether the second entity has an available MDT report.
Indication of That The Reporting Needs To Include Connected-State Measurement Result: an indication used to indicate whether it needs to include some and/or all Connected-state measurement results when reporting. This indication may be represented by a single bit. For example, when the field value is 1, it needs to include some and/or all Connected-state measurement results, and when the field value is 0, it doesn't need to include some and/or all Connected-state measurement results; or when the field value is 1, it doesn't need to include some and/or all Connected-state measurement results, and when the field value is 0, it needs to include some and/or all Connected-state measurement results.
Collection Scope of Connected-State Measurement Result That Required For Reporting: used to indicate the collection scope of Connected-state measurement results that required to be reported when it needs to include some and/or all Connected-state measurement results when reporting. The scope may be a certain time period, time point, geographical location range, slice identification and/or slice identification list, cell identification and/or cell identification list, beam identification and/or beam identification list, entity identification and/or entity identification list, operator identification and/or operator identification list, etc.
Information of a Requesting and/or configuring Node and/or Cell: information of a node and/or cell that requests and/or configures the reporting and/or collection, and/or information of a node and/or cell to which location information needs to be transmitted. It may be a node identification or a cell identification. It is used to inform the node and/or cell to which the collected location information should be transmitted.
Node and/or Cell for Location information Reporting: used to inform information of a node and/or cell to which location information needs to be reported. It may be a node identification or a cell identification. It is used to inform the node and/or cell to which the collected location information should be transmitted.
Final Node and/or Cell for Location information Reporting: used to inform information of a node and/or cell to which location information needs to be reported finally. It may be a node identification or a cell identification. It is used to inform the node and/or cell to which the collected location information should be transmitted finally. After an entity receiving the information, if the entity is not a final node and/or cell for location information reporting, it needs to subsequently forward the collection and/or reception to the final node and/or cell for location information reporting, or to other nodes to finally reach the final node and/or cell for location information reporting.

In some implementations, the second information may also include a trajectory prediction result reporting configuration and/or request. The trajectory prediction result reporting configuration and/or request may include one or more of the following:
Trajectory Prediction Reporting Indication: used to indicate whether the second entity needs to report a trajectory prediction result. This indication may be represented by a single bit. For example, when the field value is 1, it means that the trajectory prediction result needs to be reported, and when the field value is 0, it means that the trajectory prediction result does not need to be reported; or when the field value is 1, it means that the trajectory prediction results do not need to be reported, and when the field value is 0, it means that the trajectory prediction results need to be reported.
Only Trajectory Prediction Reporting Indication: used to indicate whether the second entity only needs to report a trajectory prediction result. This indication may be represented by a single bit. For example, when the field value is 1, it means that only the trajectory prediction result needs to be reported, and when the field value is 0, it means that other results need to be reported; or when the field value is 1, it means that other results need to be reported, and when the field value is 0, it means that only the trajectory prediction result needs to be reported.
Registration Request For Prediction Result Reporting: used to indicate related information of at least one of the start, end or addition of a trajectory prediction result reporting.
Prediction Time of Prediction Result That Required For Reporting: used to indicate related information of a time interval and/or time point corresponding to a trajectory prediction result that is required to be reported. The prediction time may also be a period of time before and/or after a certain event occurs. A certain event may be a change of RRC state, for example, including switching from an Idle and/or Inactive state to a Connected state, or switching from a Connected state to an Idle and/or Inactive state, or switching among Idle, Inactive and Connected states, or accessing and/or leaving a cell, or accessing and/or leaving an operator, or accessing and/or leaving a slice, or accessing and/or leaving a beam, or accessing and/or leaving an entity, or having an other indication (for example, the other indication may be a Location Information Reporting Indication, or a Trajectory Prediction Reporting Indication), or a handover occurs, or receiving predicted trajectory information, or receiving predicted information, or receiving artificial intelligence machine learning related information, etc.

The time interval may be for example represented by 2*n bits, for example, the first n bits represent a start time when the prediction result is required to be reported, and the last n bits represent an end time when the prediction result is required to be reported. The time may be either a relative time or an absolute time.

The time interval requested for prediction may also be represented by separate fields, for example, and may include one or more of the following:
Start Time When The Prediction Result Is Required To Be Reported: used to indicate a corresponding start time of a trajectory prediction result that is required to be reported. The prediction start time may be, for example, a relative time or an absolute time.
End Time When The Prediction Result Is Required To Be Reported: used to indicate a corresponding end time of a trajectory prediction result that is required to be reported. The prediction end time may be, for example, a relative time or an absolute time.
Required Prediction Result Reporting Type: used to indicate whether the required trajectory prediction result reporting is single reporting or periodic reporting. The prediction result reporting type may include, for example, but not limited to, on-demand type, periodic type, event-triggering type, etc.
Required Prediction Result Reporting Period: used to indicate related information of a corresponding interval time when the required prediction result reporting is periodic reporting. The reporting period may also be the prediction time of the reported data. If there is no content about this field, it means that single reporting is applicable, and the prediction time of the single reporting is from the prediction start time to the prediction end time.
Reporting Trigger Event: used to indicate related information of trigger conditions for reporting. Only when a prediction result or an actual situation meets the reporting trigger condition, reporting is needed. For example, if long-term camping, short-term camping, ping-pong movement, or RRC state change (for example, including switching from an Idle and/or Inactive state to a Connected state, or switching from a Connected state to an Idle and/or Inactive state, or switching among Idle, Inactive and Connected states, or accessing and/or leaving a cell, or accessing and/or leaving an operator, or accessing and/or leaving a slice, or accessing and/or leaving a beam, or accessing and/or leaving an entity, or having an other indication (for example, the other indication may be a Location Information Reporting Indication), or a handover occurs, or receiving predicted trajectory information, or receiving predicted information, or receiving artificial intelligence machine learning related information, etc.) occurs, reporting is needed.
Type of Prediction Result That Required For Reporting: used to indicate related information of the type of trajectory prediction that is required to be reported. The prediction type may include, for example, but not limited to, trajectory coordinate prediction, camping cell prediction, connected serving cell prediction, trajectory special situation prediction, etc.
Prediction Content That Required For Reporting: used to indicate related information of detailed parameters of the trajectory prediction required to be reported. The parameters for prediction required to be reported may include, for example, but not limited to, time point and/or time interval, location coordinates, estimated speed (including magnitude and/or direction), cell identification (such as Cell Global ID), entity identification, beam identification, type of a trajectory special situation, coordinate and/or range of a trajectory special situation, prediction accuracy and/or reliability, etc.

Herein, the type of a trajectory special situation may include, but not limited to, longterm camping, short-term camping, ping-pong movement, etc.

Herein, the coordinate and/or range of a trajectory special situation indicates information of the location where the trajectory special situation occurs.

As an implementation, the prediction content may be related to the prediction type. For example, if the prediction type is camping cell prediction or connected serving cell prediction, the prediction content may include but not limited to time point, cell identification, prediction accuracy and/or reliability, etc. For another example, if the prediction type selects the trajectory coordinate prediction, the prediction content may include but not limited to time point and/or time interval, location coordinates, estimated speed (including magnitude and/or direction), prediction accuracy and/or reliability, etc. For another example, if the prediction type selects the type of a trajectory special situation, the prediction content may include but not limited to time point, type of a trajectory special situation, coordinate and/or range of a trajectory special situation, prediction accuracy and/or reliability, etc. For another example, if the prediction type selects the beam prediction, the prediction content may include but not limited to time point and/or time interval, beam identification, prediction accuracy and/or reliability. For another example, if the prediction type selects the entity prediction, the prediction content may include but not limited to time point and/or time interval, entity identification, prediction accuracy and/or reliability.

In some embodiments, a method for supporting location information collection according to embodiments of the present disclosure may include: a second entity feeds back third information including a location information status to a first entity, and informs the first entity of situation about location information available for the second entity, so that the first entity may select required location information and require the second entity to report the same, and may obtain location information of the second entity and/or an other entity efficiently, thus reducing unnecessary location information reporting, etc. The location information may be used for the first entity to perform model training and/or inference for trajectory prediction, and/or make network self-optimization decision, etc.

The third information may be included in one or more of the following: RRCSetupComplete, RRCResumeComplete, RRCReconfigurationComplete, RRCReestablishmentComplete, UE-MeasurementsAvailable of RRC; or one other and/or newly defined RRC and/or Xn and/or X2 and/or F1 and/or E1 and/or NG message.

In some implementations, the third information may include one or more of the following:
Location Information Available Indication: used to indicate whether the second entity has location information. This indication may be represented by a single bit. For example, when the field value is 1, it means that the second entity has location information, and when the field value is 0, it means that the second entity has no location information; or when the field value is 1, it means that the second entity has no location information, and when the field value is 0, it means that the second entity has location information.
Measurement Identification Corresponding To Available Report: used to identify the measurement identification corresponding to an available report.
Indication of RAN-side Configuration Related Report Available: used to indicate whether the second entity has a related report for measurement and/or reporting configured by the RAN-side. This indication may be represented by a single bit. For example, when the field value is 1, it means that the second entity has the report, and when the field value is 0, it means that the second entity does not have the report; or when the field value is 1, it means that the second entity does not have the report, and when the field value is 0, it means that the second entity has the report. The report may include location information, measurement results, etc. The measurement results may include one or more of the following: Reference Signal Receiving Power (RSRP), reference signal receiving quality (RSRQ), Signal to Interference plus Noise Ratio (SINR), etc.
Indication of Incremental Configuration Related Report Available: used to indicate whether the second entity has a related report corresponding to an incremental configuration. This indication may be represented by a single bit. For example, when the field value is 1, it means that the second entity has a report corresponding to an incremental configuration, and when the field value is 0, it means that the second entity has no report corresponding to an incremental configuration; or when the field value is 1, it means that the second entity has no report corresponding to an incremental configuration, and when the field value is 0, it means that the second entity has a report corresponding to an incremental configuration.
Only Location Information Available Indication: used to indicate that the second entity only has a location information report. This indication may be represented by a single bit. For example, when the field value is 1, it means that the second entity only has a location information report, and when the field value is 0, it means that the second entity does not only have a location information report; or when the field value is 1, it means that the second entity does not only have a location information report, and when the field value is 0, it means that the second entity only has a location information report.
Continuous Measurement Result Available Indication: used to indicate whether the second entity has a continuous measurement result and/or a measurement result exceeding a recording time interval and/or a measurement result exceeding a measurement time interval. This indication may be represented by a single bit. For example, when the field value is 1, it means that the second entity has a continuous measurement result and/or a measurement result exceeding a recording time interval and/or a measurement result exceeding a measurement time interval, and when the field value is 0, it means that the second entity has no continuous measurement results and/or measurement results exceeding a recording time interval and/or measurement results exceeding a measurement time interval; or when the field value is 1, it means that the second entity has no continuous measurement results and/or measurement results exceeding a recording time interval and/or measurement results exceeding a measurement time interval, and when the field value is 0, it means that the second entity has a continuous measurement result and/or a measurement result exceeding a recording time interval and/or a measurement result exceeding a measurement time interval.
Continuous Measurement Result Upon State Transition Available Indication: used to indicate whether the second entity has a measurement result corresponding to the time of state transition. This indication may be represented by a single bit. For example, when the field value is 1, it means that the second entity has a measurement result corresponding to the time of state transition, and when the field value is 0, it means that the second entity does not have a measurement result corresponding to the time of state transition; or when the field value is 1, it means that the second entity does not have a measurement result corresponding to the time of state transition, and when the field value is 0, it means that the second entity has a measurement result corresponding to the time of state transition. The state transition includes switching from an Idle and/or Inactive state to a Connected state, or switching from a Connected state to an Idle and/or Inactive state, or switching among Idle, Inactive and Connected states, or accessing and/or leaving a cell, or accessing and/or leaving an operator, or accessing and/or leaving a slice, or accessing and/or leaving a beam, or accessing and/or leaving an entity, or receiving a further indication (for example, it may be a measurement stop indication, etc.), or receiving a new configuration, or a handover occurs, or receiving predicted trajectory information, or receiving predicted information, or receiving artificial intelligence machine learning related information.
Connected-State Measurement Result Available Indication: an indication used to indicate whether the second entity has some and/or all Connected-state measurement results. This indication may be represented by a single bit. For example, when the field value is 1, it means that the second entity has some and/or all Connected-state measurement results, and when the field value is 0, it means that the second entity does not have some and/or all Connected-state measurement results; or when the field value is 1, it means that the second entity does not have some and/or all Connected-state measurement results, and when the field value is 0, it means that the second entity does not include some and/or all Connected-state measurement results.
MDT Report Available Indication: used to indicate whether the second entity has a MDT report. This indication may be represented by a single bit. For example, when the field value is 1, it means that the second entity has a MDT report, and when the field value is 0, it means that the second entity has no MDT report; or when the field value is 1, it means that the second entity has no MDT report, and when the field value is 0, it means that the second entity has a MDT report. The MDT report includes Logged MDT Report and/or Immediate MDT Report.
Trajectory Prediction Result Available Indication: used to indicate whether the second entity has a trajectory prediction result. This indication may be represented by a single bit. For example, when the field value is 1, it means that the second entity has a trajectory prediction result, and when the field value is 0, it means that the second entity has no trajectory prediction result; or when the field value is 1, it means that the second entity has no trajectory prediction result, and when the field value is 0, it means that the second entity has a trajectory prediction result.
Available Location Information Acquisition Way: used to indicate available acquisition ways of location information. The acquisition way may include one or more of the following: acquiring by using artificial intelligence and/or machine learning models, and acquiring by using a traditional way (such as Assisted Global Navigation Satellite System (A-GNSS), Observed Time Difference Of Arrival (OTDOA), Enhanced Cell-ID (E-CID), Sensor, Wireless Local Area Network (WLAN), Bluetooth, Terrestrial Beacon System (TBS), Downlink Time Difference Of Arrival (DL-TDOA), Downlink Angle-of-Departure (DL-AoD), Multi Round Trip Time (Multi-RTT), New Radio Enhanced Cell-ID (NR E-CID), Uplink Time Difference of Arrival (UL-TDOA), Uplink Angle of Arrival (UL-AoA), etc.).
Information of a Requesting and/or configuring Node and/or Cell: information of a node and/or cell that requests and/or configures the reporting and/or collection, and/or information of a node and/or cell to which location information needs to be transmitted. It may be a node identification or a cell identification. It is used to inform the node and/or cell to which the collected location information should be transmitted.
Node and/or Cell for Location information Reporting: used to inform information of a node and/or cell to which location information needs to be reported. It may be a node identification or a cell identification. It is used to inform the node and/or cell to which the collected location information should be transmitted.
Final Node and/or Cell for Location information Reporting: used to inform information of a node and/or cell to which location information needs to be reported finally. It may be a node identification or a cell identification. It is used to inform the node and/or cell to which the collected location information should be transmitted finally. After an entity receiving the information, if the entity is not a final node and/or cell for location information reporting, it needs to subsequently forward the collection and/or reception to the final node and/or cell for location information reporting, or to other nodes to finally reach the final node and/or cell for location information reporting.

In some embodiments, a method for supporting location information collection according to embodiments of the present disclosure may include: a second entity feeds back fourth information including location information to a first entity, and the first entity may accurately identify the type of the location information and accurately obtain required location information, in order for the first entity to efficiently obtain location information of the second entity and/or an other entity, thus reducing unnecessary information interpretation by the first entity. The location information may be used for the first entity to perform model training and/or inference for trajectory prediction, and/or make network self-optimization decision, etc.

The fourth information may be included in one or more of the following: SCGFailureInformation, FailureReportSCG, UEInformationResponse, LogMeasInfo, ConnEstFailReport, Radio Link Failure Report (RLF-Report), CommonLocationInfo, LocationInfo, MeasResults, and MeasResultSCG-Failure of RRC; UE CONTEXT RELEASE message, PARTIAL UE CONTEXT TRANSFER ACKNOWLEDGE message, XN SETUP REQUEST message, XN SETUP RESPONSE message, NG-RAN NODE CONFIGURATION UPDATE message, and NG-RAN NODE CONFIGURATION UPDATE ACKNOWLEDGE message of Xn; F1 SETUP REQUEST message, F1 SETUP RESPONSE message, GNB-DU CONFIGURATION UPDATE message, GNB-DU CONFIGURATION UPDATE ACKNOWLEDGE message, GNB-CU CONFIGURATION UPDATE message, and GNB-CU CONFIGURATION UPDATE ACKNOWLEDGE message of F1; GNB-CU-UP E1 SETUP REQUEST message, GNB-CU-UP E1 SETUP RESPONSE message, GNB-CU-CP E1 SETUP REQUEST message, GNB-CU-CP E1 SETUP RESPONSE message, GNB-CU-UP CONFIGURATION UPDATE message, GNB-CU-UP CONFIGURATION UPDATE ACKNOWLEDGE message, GNB-CU-CP CONFIGURATION UPDATE message, and GNB-CU-CP CONFIGURATION UPDATE ACKNOWLEDGE of E1; or one other and/or newly defined RRC and/or Xn and/or X2 and/or F1 and/or E1 and/or NG message.

In some implementations, the location information may be interacted in the form of a MDT report and/or a RRC Container.

In some implementations, the fourth information may include one or more of the following:
Location Information: used to indicate location information and/or location information list of the second entity and/or an other entity. The location information may be an absolute location, a relative location, etc. The location information may be expressed by latitude and longitude, absolute coordinates, relative coordinates, serving cell, camping cell, etc. The location information may include one or more of the following: time point and/or time interval, location coordinates, estimated speed (including magnitude and/or direction), cell identification (such as Cell Global ID, etc.), entity identification, beam identification, accuracy, etc. The serving cell and/or the camping cell may be represented by a cell identification. The accuracy of location information may include, for example, meter, centimeter, decimeter, kilometer, etc.
Time Corresponding To Location Information: used to indicate a time point and/or time interval when staying in a location. It may be represented by 2*n bits, for example, the first n bits represent a start time and the last n bits represent an end time. The time may be either a relative time or an absolute time. It may also be represented by separate fields, including one or more of the following:
   Start Time: used to indicate a start time. The start time may be either a relative time or an absolute time.
   End Time: used to indicate an end time. The end time may be either a relative time or an absolute time.
Identification of Entity To Which Location Information Belongs: used to indicate the identification and/or identification list of entities to which the location information belongs.
Indication of Including Location Information: used to indicate whether location information is included in a message and/or report and/or container. This indication may be represented by a single bit. For example, when the field value is 1, it means that the location information is included, and when the field value is 0, it means that the location information is not included; or when the field value is 1, it means that the location information is not included, and when the field value is 0, it means that the location information is included.
Indication of Same Location Merging To Display: used to indicate that location information corresponding to missing time points in the location information is the same as the location information in the previous location information record.
Duration of Same Location: used to indicate a duration of the location information. It may be represented by 2*n bits, for example, the first n bits represent a start time and the last n bits represent an end time. The time may be either a relative time or an absolute time. It may also be represented by separate fields, including one or more of the following:
   Start Time: used to indicate a start time. The start time may be either a relative time or an absolute time.
   End Time: used to indicate an end time. The end time may be either a relative time or an absolute time.
Measurement Identification: used to identify the measurement.
Indication of Report Corresponding To RAN-side Configuration: used to indicate whether a report corresponds to a measurement and/or report configured by the RAN-side. This indication may be represented by a single bit. For example, when the field value is 1, it means that the report corresponds to a configuration of the RAN-side, and when the field value is 0, it means that the report does not correspond to a configuration of the RAN-side; or when the field value is 1, it means that the report does not correspond to a configuration of the RAN-side, and when the field value is 0, it means that the report corresponds to a configuration of the RAN-side. The report may include location information, measurement results, etc. The measurement results may include one or more of the following: Reference Signal Receiving Power (RSRP), reference signal receiving quality (RSRQ), Signal to Interference plus Noise Ratio (SINR), etc.
Indication of Report Corresponding To Incremental Configuration: used to indicate whether a report corresponds to an incremental configuration. This indication may be represented by a single bit. For example, when the field value is 1, it means that the report corresponds to an incremental configuration, and when the field value is 0, it means that the report does not correspond to an incremental configuration; or when the field value is 1, it means that the report does not correspond to an incremental configuration, and when the field value is 0, it means that the report corresponds to an incremental configuration.
Indication of Location Information Only: used to indicate whether a report only includes location information. This indication may be represented by a single bit. For example, when the field value is 1, it means that the report only includes location information, and when the field value is 0, it means that the report includes other information; or when the field value is 1, it means that the report includes other information, and when the field value is 0, it means that the report only includes location information.
Indication of Including Continuous Measurement Result: used to indicate whether a report includes a continuous measurement result and/or a measurement result exceeding a recording time interval and/or a measurement result exceeding a measurement time interval. This indication may be represented by a single bit. For example, when the field value is 1, it means that the report includes a continuous measurement result and/or a measurement result exceeding a recording time interval and/or a measurement result exceeding a measurement time interval, and when the field value is 0, it means that the report does not include a continuous measurement result and/or a measurement result exceeding a recording time interval and/or a measurement result exceeding a measurement time interval.
Indication of Including Continuous Measurement Result Upon State Transition: used to indicate whether a report includes a measurement result corresponding to the time of state transition. This indication may be represented by a single bit. For example, when the field value is 1, it means that the report includes a measurement result corresponding to the time of state transition, and when the field value is 0, it means that the report does not include a measurement result corresponding to the time of state transition; or when the field value is 1, it means that the report does not include a measurement result corresponding to the time of state transition, and when the field value is 0, it means that the report includes a measurement result corresponding to the time of state transition. The state transition includes switching from an Idle and/or Inactive state to a Connected state, or switching from a Connected state to an Idle and/or Inactive state, or switching among Idle, Inactive and Connected states, or accessing and/or leaving a cell, or accessing and/or leaving an operator, or accessing and/or leaving a slice, or accessing and/or leaving a beam, or accessing and/or leaving an entity, or receiving a further indication (for example, it may be a measurement stop indication, etc.), or receiving a new configuration, or a handover occurs, or receiving predicted trajectory information, or receiving predicted information, or receiving artificial intelligence machine learning related information.
Indication of Including Connected-State Measurement Result: an indication used to indicate whether a report includes some and/or all Connected-state measurement results. This indication may be represented by a single bit. For example, when the field value is 1, it means that the report includes some and/or all Connected-state measurement results, and when the field value is 0, it means that the report does not include some and/or all Connected-state measurement results; or when the field value is 1, it means that the report does not include some and/or all Connected-state measurement results, and when the field value is 0, it means that the report includes some and/or all Connected-state measurement results.
MDT Report Indication: used to indicate whether the reported content includes a MDT report. This indication may be represented by a single bit. For example, when the field value is 1, it means that a MDT report is included, and when the field value is 0, it means that a MDT report is not included; or when the field value is 1, it means that a MDT report is not included, and when the field value is 0, it means that a MDT report is included. The MDT report includes Logged MDT Report and/or Immediate MDT Report.
MDT Report: the MDT report includes Logged MDT Report and/or Immediate MDT Report.
Indication of Including Trajectory Prediction Result: used to indicate whether a report includes a trajectory prediction result. This indication may be represented by a single bit. For example, when the field value is 1, it means that the report includes a trajectory prediction result, and when the field value is 0, it means that the report does not include a trajectory prediction result; or when the field value is 1, it means that the report does not include a trajectory prediction result, and when the field value is 0, it means that the report includes a trajectory prediction result.
Prediction Content Prediction Identification: used to indicate related information about whether trajectory information is prediction content. The Prediction Content Prediction Identification field may be represented by a single bit. For example, when the field value is 1, it means that the information is prediction content, and when the field value is 0, it means that the information is actual status content.
Indication of Obtaining Location Information By Prediction: used to indicate whether location information is obtained by prediction. The prediction may be made by artificial intelligence and/or machine learning models, or by a preset mathematical method. If the fourth information exists in a RRC message, this field may be in locationInfo, and/or CommonLocationInfo, and/or locationSource of CommonLocationInfo. This identification field may be represented by a single bit. For example, when the field value is 1, it means that the information is obtained by prediction, and when the field value is 0, it means that the information is not obtained by prediction; or when the field value is 1, it means that the information is not obtained by prediction, and when the field value is 0, it means that the information is obtained by prediction.
Indication of Obtaining Location Information By Artificial Intelligence and/or Machine Learning Model: used to indicate whether location information is obtained by artificial intelligence and/or machine learning model. The location information may be obtained by a positioning function performed by artificial intelligence and/or machine learning model, or may be obtained by a trajectory prediction function performed by artificial intelligence and/or machine learning model. This identification field may be represented by a single bit. For example, when the field value is 1, it means that the information is obtained by artificial intelligence and/or machine learning model, and when the field value is 0, it means that the information is not obtained by artificial intelligence and/or machine learning model; or when the field value is 1, it means that the information is not obtained by artificial intelligence and/or machine learning model, and when the field value is 0, it means that the information is obtained by artificial intelligence and/or machine learning model.
Requested Content Confirmation: related information used to confirm whether requested trajectory prediction content is predicted. The Requested Content Confirmation may be represented by a single bit, for example. For example, when the field value is 1, it means that all the requested contents can be predicted, and when the field value is 0, it means that the requested contents cannot be predicted. For example, confirmation of the requested content may be in the form of bitmap, and the requested content for prediction can be confirmed one by one. For example, each bit corresponds to one prediction content. For example, when the field value is 1, it means that predicted trajectory information of the corresponding prediction content can be transmitted, and when the field value is 0, it means that the predicted trajectory information of the corresponding prediction content cannot be transmitted. For example, the Requested Content Confirmation may also be that separate fields indicates a confirmation of different prediction content.
Prediction Time: used to indicate related information of a prediction time interval and/or time point when trajectory prediction data is applicable and/or effective. The prediction time may also be a period of time before and/or after a certain event occurs. A certain event may be a change of RRC state, for example, including switching from an Idle and/or Inactive state to a Connected state, or switching from a Connected state to an Idle and/or Inactive state, or switching among Idle, Inactive and Connected states, or accessing and/or leaving a cell, or accessing and/or leaving an operator, or accessing and/or leaving a slice, or accessing and/or leaving a beam, or accessing and/or leaving an entity, or receiving a further indication (for example, it may be a prediction stop indication, etc.), or receiving a new configuration, or a handover occurs, or receiving predicted trajectory information, or receiving predicted information, or receiving artificial intelligence machine learning related information, etc.

The prediction time interval may be represented by 2*n bits, for example, the first n bits represent a start time of trajectory prediction, and the last n bits represent an end time of trajectory prediction. The time may be either a relative time or an absolute time. The prediction time interval may also be represented by separate fields, for example, and may include one or more of the following:
Prediction Start Time: used to indicate the start time when the trajectory prediction result is applicable and/or effective. The prediction start time may be, for example, a relative time or an absolute time.
Prediction End Time: used to indicate the end time when the trajectory prediction result is applicable and/or effective. The prediction end time may be, for example, a relative time or an absolute time.
Predicted Type: used to indicate related information of the type of the trajectory prediction performed. The predicted types include but not limited to trajectory coordinate prediction, camping cell prediction, connected serving cell prediction, trajectory special situation prediction, etc.
Predicted Content: used to indicate related information of the parameters of the trajectory prediction performed. Predicted parameters may include, for example, but not limited to, time point and/or time interval, location coordinates, estimated speed (including magnitude and/or direction), cell identification (such as Cell Global ID), entity identification, beam identification, type of a trajectory special situation, coordinate and/or range of a trajectory special situation, prediction accuracy and/or reliability, etc.

Herein, the type of a trajectory special situation may include, for example, but not limited to, long-term camping, short-term camping, ping-pong movement, etc.

Herein, the coordinate and/or range of a trajectory special situation indicates information of the location where the trajectory special situation occurs.

As an implementation, the prediction content may be related to the prediction type. For example, if the prediction type is camping cell prediction or connected serving cell prediction, the prediction content may include but not limited to time point, cell identification, prediction accuracy and/or reliability, etc. For another example, if the prediction type selects the trajectory coordinate prediction, the prediction content may include but not limited to time point and/or time interval, location coordinates, estimated speed (including magnitude and/or direction), prediction accuracy and/or reliability, etc. For another example, if the prediction type selects the type of a trajectory special situation, the prediction content may include but not limited to time point, type of a trajectory special situation, coordinate and/or range of a trajectory special situation, prediction accuracy and/or reliability, etc. For another example, if the prediction type selects the beam prediction, the prediction content may include but not limited to time point and/or time interval, beam identification, prediction accuracy and/or reliability. For another example, if the prediction type selects the entity prediction, the prediction content may include but not limited to time point and/or time interval, entity identification, prediction accuracy and/or reliability.
Trigger Event For This Reporting: used to indicate related information of trigger conditions triggering this reporting. For example, if long-term camping, short-term camping, ping-pong movement, or RRC state change (for example, including switching from an Idle and/or Inactive state to a Connected state, or switching from a Connected state to an Idle and/or Inactive state, or switching among Idle, Inactive and Connected states, or accessing and/or leaving a cell, or accessing and/or leaving an operator, or accessing and/or leaving a slice, or accessing and/or leaving a beam, or accessing and/or leaving an entity, or having an other indication (for example, the other indication may be a Location Information Reporting Indication), or a handover occurs, or receiving predicted trajectory information, or receiving predicted information, or receiving artificial intelligence machine learning related information, etc.) occurs, reporting is needed.
Information of a Requesting and/or configuring Node and/or Cell: information of a node and/or cell that requests and/or configures the reporting and/or collection, and/or information of a node and/or cell to which location information needs to be transmitted. It may be a node identification or a cell identification. It is used to inform the node and/or cell to which the collected location information should be transmitted.
Node and/or Cell for Location information Reporting: used to inform information of a node and/or cell to which location information needs to be reported. It may be a node identification or a cell identification. It is used to inform the node and/or cell to which the collected location information should be transmitted.
Final Node and/or Cell for Location information Reporting: used to inform information of a node and/or cell to which location information needs to be reported finally. It may be a node identification or a cell identification. It is used to inform the node and/or cell to which the collected location information should be transmitted finally. After an entity receiving the information, if the entity is not a final node and/or cell for location information reporting, it needs to subsequently forward the collection and/or reception to the final node and/or cell for location information reporting, or to other nodes to finally reach the final node and/or cell for location information reporting.
Related Information For Cause Of Trajectory Prediction Request Failure: the causes may include at least one of the following: trajectory prediction failure, no prediction capability, no trajectory prediction capability, and insufficient data.

In some embodiments, a method for supporting location information collection according to embodiments of the present disclosure may include: a first entity transmits fifth information for capability negotiation (for example, information collection and/or reporting negotiation) to a second entity, so that the second entity may transmit its own capability for information collection and/or reporting to the first entity, in order for the first entity to know the information collection and/or reporting capability acceptable to the second entity, so as to avoid the collection and/or reporting configuration and/or request by the first entity to the second entity from going beyond the capability of the second entity. The information may include location information, traffic information, user experience information, quality of service information, privacy information, prediction capability, etc. The prediction may include trajectory prediction, traffic prediction, user experience prediction, quality of service prediction, privacy data prediction, etc.

The fifth information may be included in a RRC and/or Xn and/or X2 and/or F1 and/or E1 and/or NG message and/or NAS.

In some implementations, the fifth information may include one or more of the following:
Request for Information Reporting Consent: used to inquire whether the second entity can collect and/or report information.
Request for Information Collection Interval: used to inquire the second entity the acceptable information collection interval thereof.
Candidate Interval for Information Collection: used to provide the second entity with a candidate information collection interval. The interval may be a single interval or a plurality of intervals, such as an interval list.
Request for Information Collection Times: used to inquire the second entity the acceptable information collection times thereof.
Candidate Times for Information Collection: used to provide the second entity with a candidate information collection times. The times may be a single piece of times, or multiple pieces of times, such as a list of times.
Request for Prediction Capability: used to inquire whether the second entity can perform information prediction.
Request for Prediction Content: used to inquire the second entity about the content that can be predicted.
Request for Prediction Interval: used to inquire the second entity the acceptable time interval for prediction.
Candidate Prediction Interval: used to provide the second entity with a candidate interval for prediction. The interval may be a single interval or a plurality of intervals, such as an interval list.
Request for Prediction Times: used to inquire the second entity how many times it can make predictions.
Candidate Prediction Times: used to provide the second entity with a candidate prediction times. The times may be a single piece of times, or multiple pieces of times, such as a list of times.
Request for Interval Applicable and/or Valid To Prediction Result: used to inquire about the applicable and/or valid time interval corresponding to a result predicted by the second entity.
Candidate Interval Applicable and/or Valid To Prediction Result: used to provide the second entity with an alternative applicable and/or valid time interval corresponding to a result predicted by the second entity.

In some implementations, the second entity may transmit its own information collection and/or reporting capability (for example, through sixth information) to the first entity according to the fifth information and/or its own situation, so that the first entity can know the information collection and/or reporting capability acceptable to the second entity. As mentioned above, the information may include location information, traffic information, user experience information, quality of service information, privacy information, prediction capability, etc. The prediction may include trajectory prediction, traffic prediction, user experience prediction, quality of service prediction, privacy data prediction, etc.

The sixth information may be included in a RRC and/or Xn and/or X2 and/or F1 and/or E1 and/or NG and/or NAS message.

In some implementations, the sixth information may include one or more of the following:
Information Reporting Consent: used to indicate whether the second entity can collect and/or report information. The consent may be represented by a single bit. For example, when the field value is 1, it means that the second entity can collect and/or report information, and when the field value is 0, it means that the second entity cannot collect and/or report information; or when the field value is 1, it means that the second entity cannot collect and/or report information, and when the field value is 0, it means that the second entity can collect and/or report information.
Acceptable Information Content To Be Collected/Reported: used to indicate the content that the second entity can collect and/or report. The content may include location information, traffic information, user experience information, quality of service information, privacy information, etc.
Acceptable Information Collection Interval: used to indicate the acceptable information collection interval of the second entity. The interval may be a single interval or a plurality of intervals, such as an interval list.
Acceptable Information Collection Times: used to indicate the acceptable information collection times of the second entity. The times may be a single piece of times, or multiple pieces of times, such as a list of times.
Prediction Capability Reporting: used to report whether the second entity can perform information prediction. This field may be represented by a single bit. For example, when the field value is 1, it means that the second entity can perform information prediction, and when the field value is 0, it means that the second entity cannot perform information prediction; or when the field value is 1, it means that the second entity cannot perform information prediction, and when the field value is 0, it means that the second entity can perform information prediction.
Predictable Content: used to indicate the predictable content of the second entity. The content may include trajectory prediction, traffic prediction, user experience prediction, quality of service prediction, privacy data prediction, etc.
Acceptable Prediction Interval: used to indicate the acceptable prediction interval of the second entity. The interval may be a single interval or a plurality of intervals, such as an interval list.
Acceptable Prediction Times: used to indicate the acceptable prediction times of the second entity. The times may be a single piece of times, or multiple pieces of times, such as a list of times.
Acceptable Interval Applicable and/or Valid To Prediction Result: used to indicate the applicable and/or valid time interval corresponding to a prediction result that is acceptable to the second entity. The interval may be a single interval or a plurality of intervals, such as an interval list.

The network self-optimization decision described in the present disclosure may include network energy saving, load balancing, coverage optimization, mobility optimization and/or management, model decision, etc. Herein, the model decision includes evaluating the accuracy and/or confidence of a model, triggering a training process and so on. In an implementation, if the accuracy of a model is lower than a certain value, a training process is triggered and/or the current model is unavailable.

The configurations and/or policies in the present disclosure may include configurations and policies of networks, and may also include configurations and/or policies related to artificial intelligence machine learning. For example, herein, the model includes evaluating the accuracy and/or confidence of a model, triggering a training process and so on. In an implementation, if the accuracy of a model is lower than a certain value, a training process is triggered and/or the current model is unavailable.

Model training and inference in the present disclosure may also include performance evaluation, decision making, etc. of artificial intelligence and/or machine learning. In an implementation, the performance evaluation may include an evaluation of the accuracy and/or confidence of a model. In an implementation, if the accuracy of a model is lower than a certain value, a training process is triggered and/or the current model is unavailable. In an implementation, the decision may include whether a model is available, whether a model needs to be retrained, whether a model needs to be deactivated and/or activated, etc.

The ‘result’ and ‘report’ in the present disclosure can be used interchangeably.

In the present disclosure, the location and/or trajectory information may be location coordinates, serving cell, camping cell, time point and/or time interval, estimated speed (including magnitude and/or direction), cell identification (such as Cell Global ID, etc.), entity identification, beam identification, etc. The serving cell and/or the camping cell may be represented by a cell identification.

In the present disclosure, trajectory information includes one or more piece of location information. Trajectory information and location information can also refer to each other.

In the present disclosure, time information, such as time point and/or time interval, etc., may also be represented by means of time stamp, timer, time length, time point and time interval.

In the present disclosure, the cell identification may also be a cell identification of a non-public network, for example, it may be one or more of the following: a Public Land Mobile Network (PLMN) identifier, a Network Identifier (NID), a Closed Access Group (CAG) identifier, a combination of PLMN identifier and NID, a combination of PLMN identifier and CAG identifier, etc.

In the present disclosure, an Idle state may be an RRC Idle state or a CM Idle state;

an Inactive state may be an RRC Inactive state; a Connected state may be a RRC Connected state or a CM Connected state. The Active state and the Connected state may refer to each other.

In the present disclosure, the location information may also be extended to other measurement information, such as measurement report information, MDT measurement information, etc.

Exemplary embodiments of the present disclosure will be further described below with reference to the accompanying drawings. One or more of the implementations shown in the various embodiments, various implementations, and various drawings in the present disclosure can be implemented individually or in combination in various ways.

The text and drawings are provided as examples only to help understand the present disclosure. They should not be interpreted as limiting the scope of the present disclosure in any way. Although certain embodiments and examples have been provided, based on the disclosure herein, it will be apparent to those skilled in the art that changes may be made to the illustrated embodiments and examples without departing from the scope of the present disclosure.

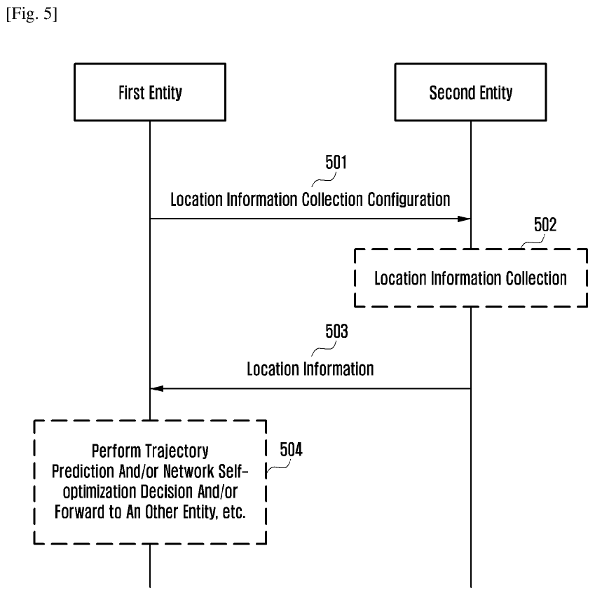

FIG. 5 illustrates a schematic diagram of one aspect of a method of supporting location information collection according to embodiments of the present disclosure. Specifically, FIG. 5 shows a process of exchanging location information between two entities, so as to provide the location information of a second entity and/or an other entity to a first entity, so that the first entity can perform trajectory prediction and/or network self-optimization decision, etc. In some implementations, for example, the first entity may be a gNB or gNB-CU or gNB-DU or gNB CU-CP or gNB CU-UP or en-gNB or eNB or ng-eNB, and the second entity may be a UE. In other implementations, for example, the first entity may be a gNB or gNB-CU or gNB CU-CP or en-gNB or eNB or ng-eNB, and the second entity may be a gNB or gNB-CU or gNB-DU or gNB CU-CP or gNB CU-UP or en-gNB or eNB or ng-eNB. In yet other embodiments, for example, the first entity may be an AMF or SMF or MME, and the second entity may be a gNB or gNB-CU or gNB CU-CP or en-gNB or eNB or ng-eNB. In still other implementations, for example, the first entity may be a gNB or gNB-CU or gNB CU-CP or en-gNB or eNB or ng-eNB, and the second entity may be an AMF or SMF or MME.

Step 501: the first entity transmits a location information collection configuration to the second entity. The location information collection configuration may be the aforementioned first information.

Step 502: the second entity collects location information of the second entity and/or an other entity.

Step 503: the second entity reports the location information to the first entity. The location information may be the aforementioned fourth information.

Step 504: the first entity performs trajectory prediction and/or network self-optimization decision setting based on the collected location information and/or forwards it to an other entity, etc.

If the configuration information in step 501 requires the second entity to report periodically, step 503 may be performed periodically.

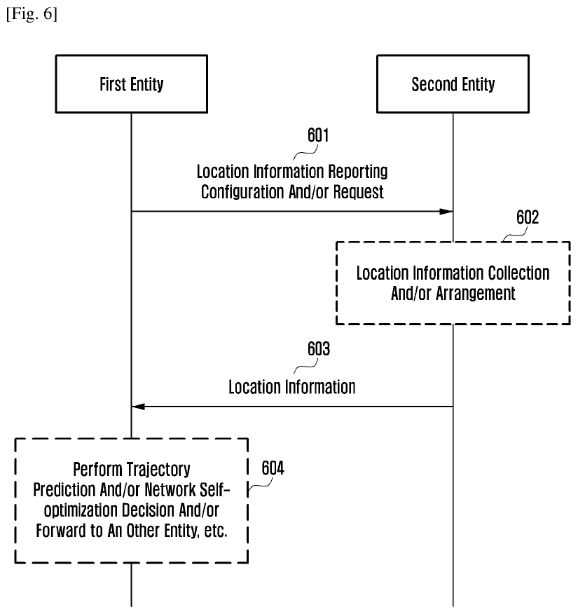

FIG. 6 illustrates a schematic diagram of one aspect of a method of supporting location information collection according to embodiments of the present disclosure. Specifically, FIG. 6 shows a process of exchanging location information between two entities, so as to provide location information of a second entity and/or an other entity to a first entity, so that the first entity can perform trajectory prediction and/or network self-optimization decision, etc. In some implementations, for example, the first entity may be a gNB or gNB-CU or gNB-DU or gNB CU-CP or gNB CU-UP or en-gNB or eNB or ng-eNB, and the second entity may be a UE. In other implementations, for example, the first entity may be a gNB or gNB-CU or gNB CU-CP or en-gNB or eNB or ng-eNB, and the second entity may be a gNB or gNB-CU or gNB-DU or gNB CU-CP or gNB CU-UP or en-gNB or eNB or ng-eNB. In yet other embodiments, for example, the first entity may be an AMF or SMF or MME, and the second entity may be a gNB or gNB-CU or gNB CU-CP or en-gNB or eNB or ng-eNB. In still other implementations, for example, the first entity may be a gNB or gNB-CU or gNB CU-CP or en-gNB or eNB or ng-eNB, and the second entity may be an AMF or SMF or MME.

Step 601: the first entity transmits a location information reporting configuration and/or request to the second entity. The location information reporting configuration and/or request may be the aforementioned second information.

Step 602: the second entity collects location information of the second entity and/or an other entity.

Step 603: the second entity reports the location information to the first entity. The location information may be the aforementioned fourth information.

Step 604: the first entity performs trajectory prediction and/or network self-optimization decision setting based on the collected location information and/or forwards it to an other entity, etc.

If the reporting configuration and/or request information in step 601 requires the second entity to report periodically, step 603 may be performed periodically.

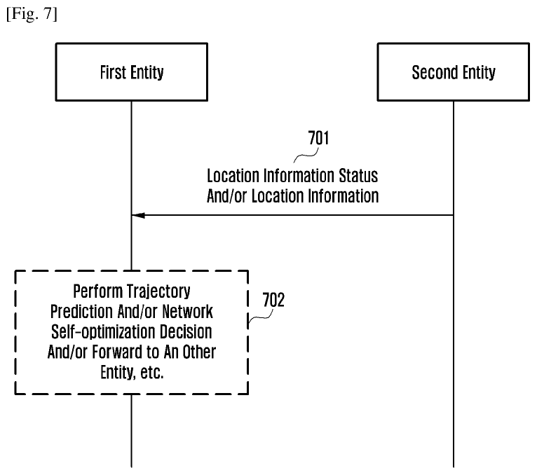

FIG. 7 illustrates a schematic diagram of one aspect of a method of supporting location information collection according to embodiments of the present disclosure. Specifically, FIG. 7 shows a process of exchanging location information status and/or location information between two entities, so as to provide the location information status and/or location information of a second entity and/or an other entity to a first entity, so that the first entity can perform trajectory prediction and/or network self-optimization decision, etc. In some implementations, for example, the first entity may be a gNB or gNB-CU or gNB-DU or gNB CU-CP or gNB CU-UP or en-gNB or eNB or ng-eNB, and the second entity may be a UE. In other implementations, for example, the first entity may be a gNB or gNB-CU or gNB CU-CP or en-gNB or eNB or ng-eNB, and the second entity may be a gNB or gNB-CU or gNB-DU or gNB CU-CP or gNB CU-UP or en-gNB or eNB or ng-eNB. In yet other embodiments, for example, the first entity may be an AMF or SMF or MME, and the second entity may be a gNB or gNB-CU or gNB CU-CP or en-gNB or eNB or ng-eNB. In still other implementations, for example, the first entity may be a gNB or gNB-CU or gNB CU-CP or en-gNB or eNB or ng-eNB, and the second entity may be an AMF or SMF or MME.

Step 701: the second entity reports location information status and/or location information to the first entity. The location information status may be the aforementioned third information. The location information may be the aforementioned fourth information.

Step 702: the first entity performs trajectory prediction and/or network self-optimization decision setting based on the collected location information and/or forwards it to an other entity, etc.

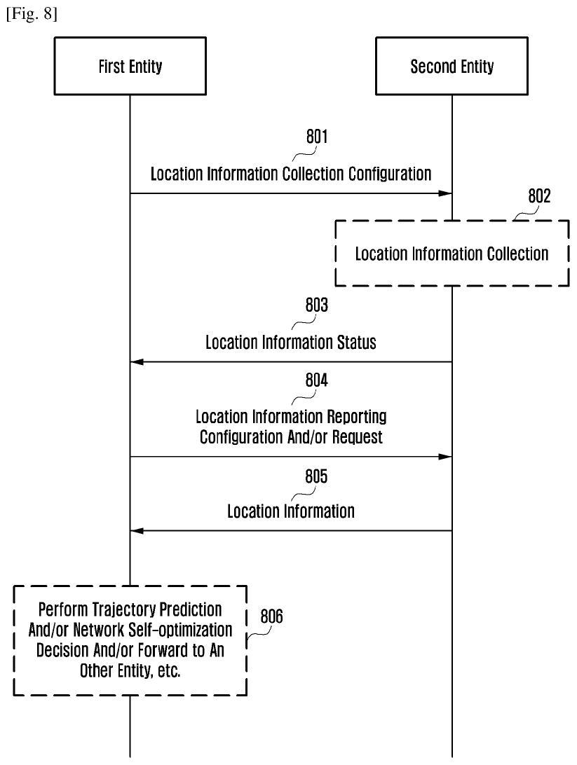

FIG. 8 illustrates a schematic diagram of one aspect of a method of supporting location information collection according to embodiments of the present disclosure. Specifically, FIG. 8 shows a process of exchanging location information between two entities, so as to provide location information of a second entity and/or an other entity to a first entity, so that the first entity can perform trajectory prediction and/or network self-optimization decision, etc. In some implementations, for example, the first entity may be a gNB or gNB-CU or gNB-DU or gNB CU-CP or gNB CU-UP or en-gNB or eNB or ng-eNB, and the second entity may be a UE. In other implementations, for example, the first entity may be a gNB or gNB-CU or gNB CU-CP or en-gNB or eNB or ng-eNB, and the second entity may be a gNB or gNB-CU or gNB-DU or gNB CU-CP or gNB CU-UP or en-gNB or eNB or ng-eNB. In yet other embodiments, for example, the first entity may be an AMF or SMF or MME, and the second entity may be a gNB or gNB-CU or gNB CU-CP or en-gNB or eNB or ng-eNB. In still other implementations, for example, the first entity may be a gNB or gNB-CU or gNB CU-CP or en-gNB or eNB or ng-eNB, and the second entity may be an AMF or SMF or MME.

Step 801: the first entity transmits a location information collection configuration to a second entity. The location information collection configuration may be the aforementioned first information.

Step 802: the second entity collects location information of the second entity and/or an other entity.

Step 803: the second entity reports location information status to the first entity. The location information status may be the aforementioned third information.

Step 804: the first entity transmits a location information reporting configuration and/or request to the second entity. The location information reporting configuration and/or request may be the aforementioned second information.

Step 805: the second entity reports the location information to the first entity. The location information may be the aforementioned fourth information.

Step 806: the first entity performs trajectory prediction and/or network self-optimization decision setting based on the collected location information and/or forwards it to an other entity, etc.

In some implementations, step 801 may be omitted, for example, the location information collection configuration may be configured by an other entity to the second entity, or the second entity may collect location information autonomously without the location information collection configuration.

If the configuration information in step 801 and/or the reporting configuration and/or request information in step 804 require the second entity to report periodically, step 805 may be performed periodically.

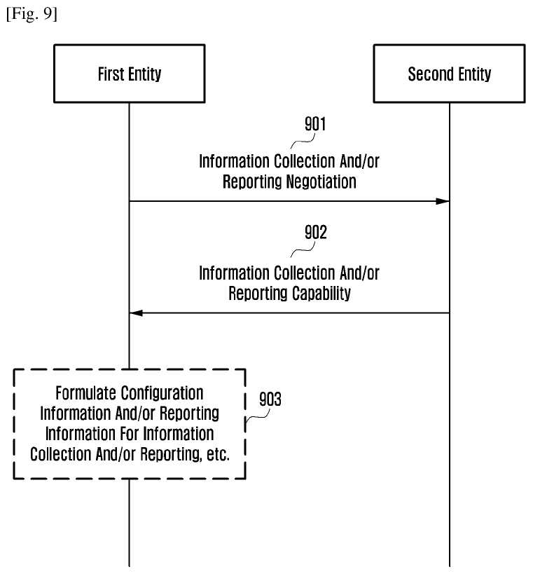

FIG. 9 illustrates a schematic diagram of one aspect of a method of supporting location information collection according to embodiments of the present disclosure. Specifically, FIG. 9 shows a process of exchanging information collection and/or reporting capabilities between two entities, so as to provide the information collection and/or reporting capabilities of a second entity and/or an other entity to a first entity, so that the first entity can, for example, formulate configuration information and/or reporting information for information collection and/or reporting based on the capabilities, etc. In some implementations, for example, the first entity may be a gNB or gNB-CU or gNB-DU or gNB CU-CP or gNB CU-UP or en-gNB or eNB or ng-eNB, and the second entity may be a UE. In other implementations, for example, the first entity may be a gNB or gNB-CU or gNB CU-CP or en-gNB or eNB or ng-eNB, and the second entity may be a gNB or gNB-CU or gNB-DU or gNB CU-CP or gNB CU-UP or en-gNB or eNB or ng-eNB. In yet other embodiments, for example, the first entity may be an AMF or SMF or MME, and the second entity may be a gNB or gNB-CU or gNB CU-CP or en-gNB or eNB or ng-eNB. In still other implementations, for example, the first entity may be a gNB or gNB-CU or gNB CU-CP or en-gNB or eNB or ng-eNB, and the second entity may be an AMF or SMF or MME.

Step 901: the first entity transmits negotiation information for information collection and/or reporting to the second entity. The negotiation information for information collection and/or reporting may be the aforementioned fifth information.

Step 902: the second entity reports the information collection and/or reporting capability to the first entity. The information indicating the capability may be the aforementioned sixth information.

Step 903: the first entity formulates configuration information and/or reporting information for information collection and/or reporting based on the acquired information collection and/or reporting capability, etc.

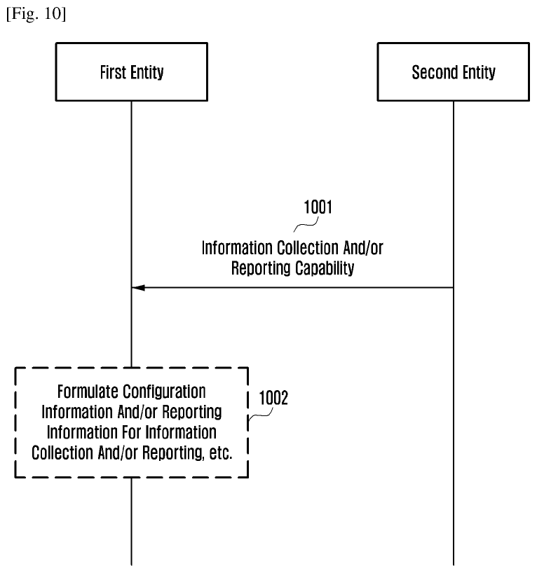

FIG. 10 illustrates a schematic diagram of one aspect of a method of supporting location information collection according to embodiments of the present disclosure. Specifically, FIG. 10 shows a process of exchanging information collection and/or reporting capabilities between two entities, so as to provide the information collection and/or reporting capabilities of a second entity and/or an other entity to a first entity, so that the first entity can, for example, formulate configuration information and/or reporting information for information collection and/or reporting based on the capabilities, etc. In some implementations, for example, the first entity may be a gNB or gNB-CU or gNB-DU or gNB CU-CP or gNB CU-UP or en-gNB or eNB or ng-eNB, and the second entity may be a UE. In other implementations, for example, the first entity may be a gNB or gNB-CU or gNB CU-CP or en-gNB or eNB or ng-eNB, and the second entity may be a gNB or gNB-CU or gNB-DU or gNB CU-CP or gNB CU-UP or en-gNB or eNB or ng-eNB. In yet other embodiments, for example, the first entity may be an AMF or SMF or MME, and the second entity may be a gNB or gNB-CU or gNB CU-CP or en-gNB or eNB or ng-eNB. In still other implementations, for example, the first entity may be a gNB or gNB-CU or gNB CU-CP or en-gNB or eNB or ng-eNB, and the second entity may be an AMF or SMF or MME.

Step 1001: the second entity reports an information collection and/or reporting capability to the first entity. The information indicating the capability may be the aforementioned sixth information.

Step 1002: the first entity formulates configuration information and/or reporting information for information collection and/or reporting based on the acquired information collection and/or reporting capability, etc.

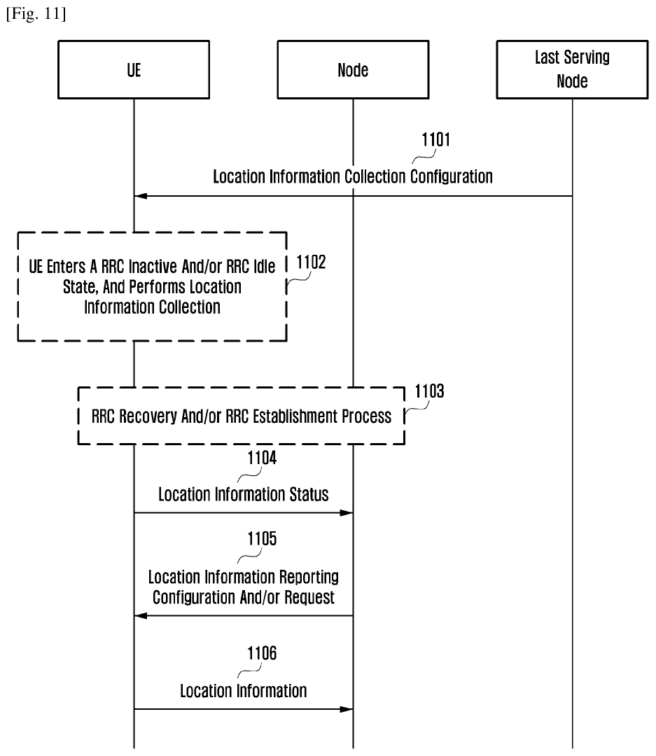

FIG. 11 illustrates a schematic diagram of one aspect of a method of supporting location information collection according to embodiments of the present disclosure. Specifically, FIG. 11 shows a process of a node and/or a last serving node collecting user location information, in which the last serving node configures the user to collect location information, and the node informs the user of the node's reporting requirements, in order for the user to report the location information required by the node, and provide the user's location information to the node for the node to perform trajectory prediction and/or network self-optimization decision, etc., so as to reduce unnecessary location information reporting and improve reporting efficiency. In some implementations, for example, the node may be a gNB or gNB-CU or gNB CU-CP or en-gNB or eNB or ng-eNB, and the last serving node may be a gNB or gNB-CU or gNB CU-CP or en-gNB or eNB or ng-eNB.

Step 1101: the last serving node transmits a location information collection configuration to the user. The location information collection configuration may be the aforementioned first information.

At step 1102, the user enters a RRC Inactive and/or RRC Idle state, and starts to collect location information.

Step 1103: the node and the UE perform a RRC recovery and/or RRC establishment process.

Step 1104: the user reports a location information status to the node. The location information status may be the aforementioned third information.

Step 1105: the node transmits a location information reporting configuration and/or request to the user. The location information reporting configuration and/or request may be the aforementioned second information.

Step 1106: the user reports location information to the node. The location information may be the aforementioned fourth information. The nodes can perform trajectory prediction and/or network self-optimization decision setting based on the collected location information and/or forward it to an other entity, etc.

Herein, the information in step 1104 may be carried by a message in the RRC recovery process and/or the RRC establishment process in step 1103.

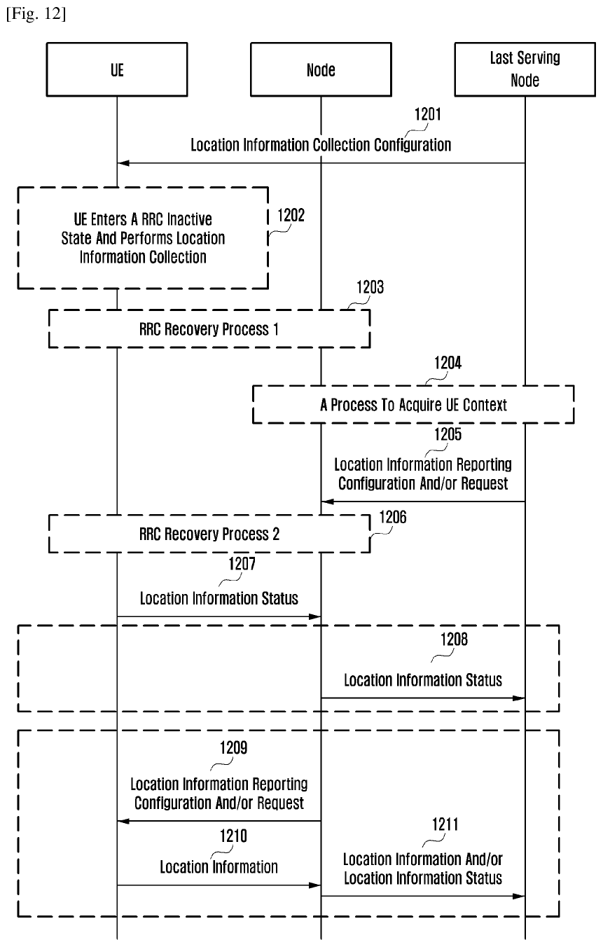

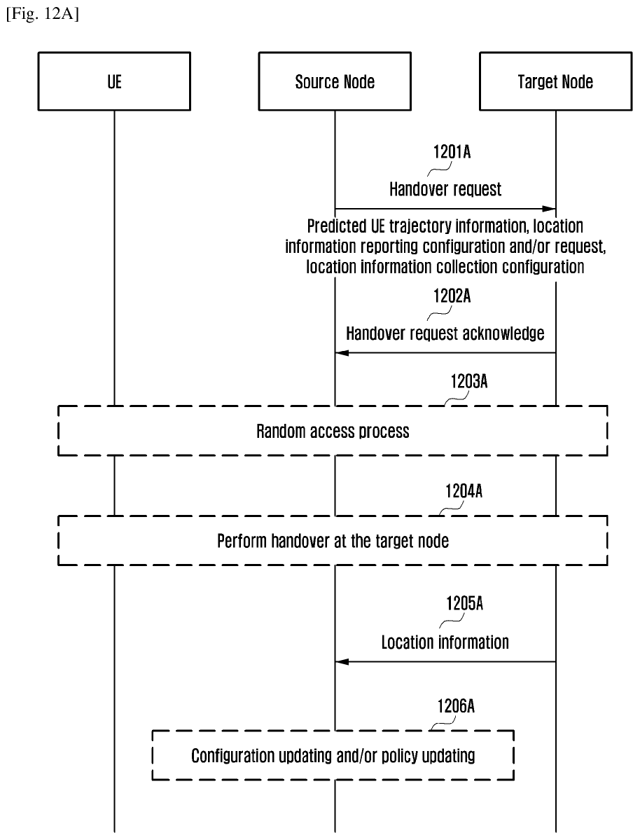

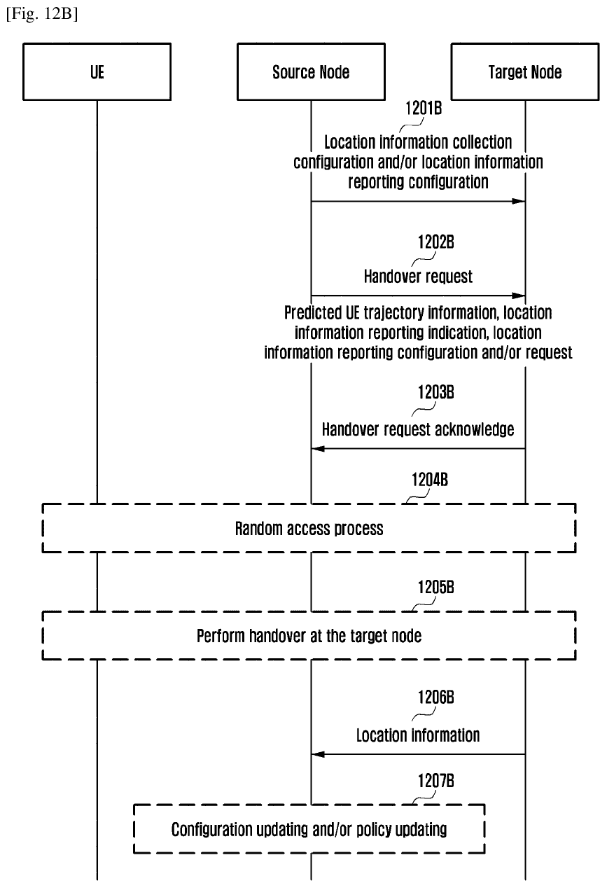

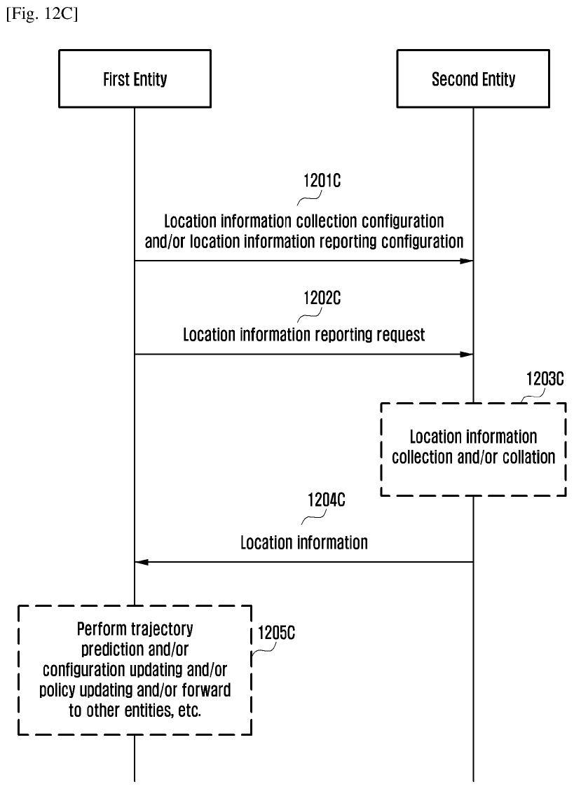

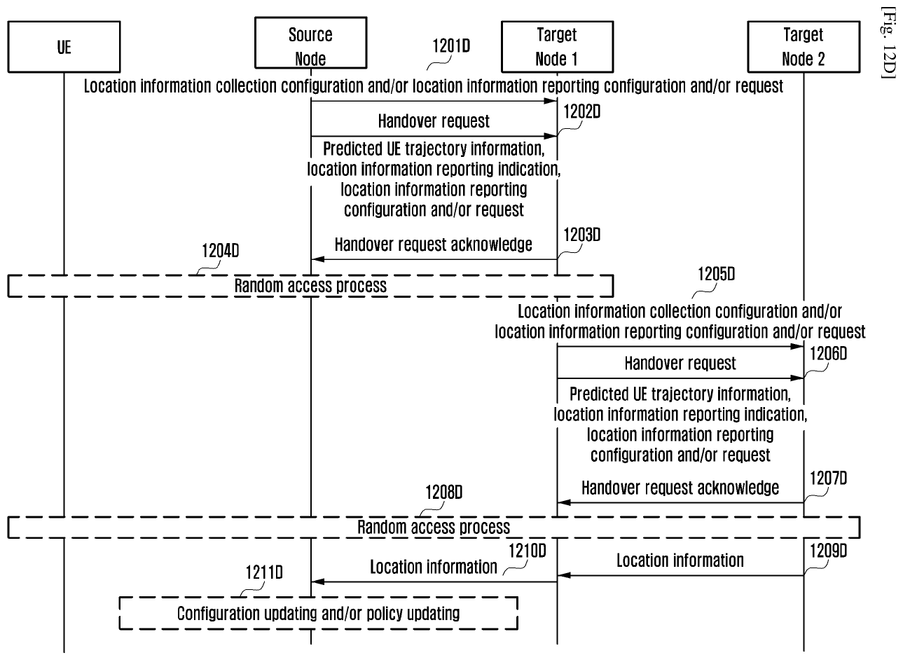

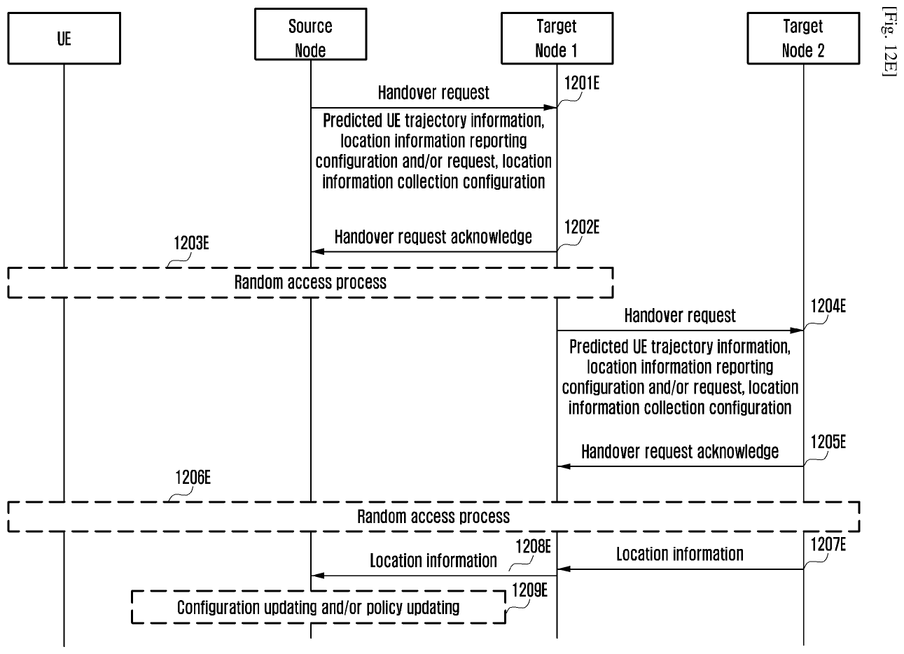

FIG. 12 illustrates a schematic diagram of one aspect of a method of supporting location information collection according to embodiments of the present disclosure. Specifically, FIG. 12 shows a process of a node and/or a last serving node collecting user location information, in which the last serving node configures the user to collect location information, and the UE connects to the node after the RRC Connected state is restored, and through the coordination of the node, the user's location information is provided to the node and/or the last serving node for the node and/or the last serving node to perform trajectory prediction and/or network self-optimization decision, etc. In some implementations, for example, the node may be a gNB or gNB-CU or gNB CU-CP or en-gNB or eNB or ng-eNB, and the last serving node may be a gNB or gNB-CU or gNB CU-CP or en-gNB or eNB or ng-eNB.

Step 1201: the last serving node transmits a location information collection configuration to the user. The location information collection configuration may be the aforementioned first information.

Step 1202: the user enters a RRC Inactive state and starts collecting location information.

Step 1203: the node and UE perform a RRC recovery process.

Step 1204: the node acquires the UE context from the last serving node.

Step 1205: the last serving node transmits a location information reporting configuration and/or request to the node. The location information reporting configuration and/or request may be the aforementioned second information.

Step 1206: the node and UE continue the RRC recovery process.

Step 1207: the user reports a location information status to the node. The location information status may be the aforementioned third information.

If the user location information status in step 1207 indicates that the information configured and/or requested in step 1205 is unavailable, then step 1208 is performed. If the user location information status in step 1207 indicates that the information configured and/or requested in step 1205 is available, then steps 1209, 1210 and 1211 are performed.

Step 1208: the node transmits the user location information status to the last serving node. The location information status may be the aforementioned third information.

Step 1209: the node transmits the location information reporting configuration and/or request to the user. The location information reporting configuration and/or request may be the aforementioned second information.

Step 1210: the user reports the location information to the node. The location information may be the aforementioned fourth information. The node performs trajectory prediction and/or network self-optimization decision setting based on the collected location information and/or forwards it to an other entity, etc.

Step 1211: if the information collected by the node in step 1210 can meet the configuration and/or request information in step 1205, the node reports the location information of the user to the last serving node. The location information may be the aforementioned fourth information. The last serving node performs trajectory prediction and/or network self-optimization decision setting based on the collected location information and/or forwards it to an other entity. If the information collected by the node in step 1210 cannot meet the configuration and/or request information in step 1205, the node transmits the user location information status to the last serving node. The location information status may be the aforementioned third information.

In some implementations, the information in step 1205 may be combined with a message in the process of obtaining the user context in step 1204. In some implementations, step 1206 may be omitted. In some implementations, step 1207 may be omitted. In some implementations, the information in step 1207 may be carried by a message in the RRC recovery process in step 1206.

FIG. 12A illustrates a schematic diagram of one aspect of a method of supporting location information collection according to embodiments of the present disclosure. Specifically, FIG. 12A shows a process in which a source node and/or a target node collect user location information. The source node transmits predicted UE trajectory information to the target node to provide reference information for the target node to determine subsequent mobile policies. In an implementation, the predicted UE trajectory information may be generated by an artificial intelligence machine learning model. The source node needs actual trajectory information of the UE to evaluate the made decisions and/or models. For example, the decisions may include trajectory prediction results and/or network self-optimization decisions and/or model results, etc., so the target node needs to transmit the actual trajectory information of the UE to the source node. The source node may use the collected actual trajectory information for model training and/or inference, and/or policy determination and/or updating, and/or configuration determination and/or updating, and/or decision determination and/or updating, etc. In some implementations, for example, the node may be a gNB or gNB-CU or gNB CU-CP or en-gNB or eNB or ng-eNB, and the last serving node may be a gNB or gNB-CU or gNB CU-CP or en-gNB or eNB or ng-eNB.

Step 1201A: the source node transmits a handover request to the target node, which may include one or more of the following: predicted UE trajectory information, location information reporting configuration and/or request, location information collection configuration, etc. The predicted UE trajectory information may be the aforementioned fourth information. The location information reporting configuration and/or request may be the aforementioned second information. The location information collection configuration may be the aforementioned first information.

Step 1202A: the target node transmits a handover request acknowledge to the source node.

Step 1203A: the target node and the UE perform a random access process.

Step 1204A: the UE performs a subsequent handover process at the target node.

Step 1205A: after the target node collects the user's location information, it transmits the location information to the source node. The location information may be the aforementioned fourth information. In an implementation, this step may be triggered by step 1201A, for example, step 1205A may be performed when the location information reporting configuration and/or request is included in step 1201A, step 1205A may be performed when the predicted UE trajectory information is included in step 1201A, step 1205A may be performed when the location information collection configuration is included in step 1201A. Or it may be a combination of the above situations, for example, step 1205A may be performed when one or more of the above information exists in step 1201A at the same time.

Step 1206A: the source node performs evaluation of the made decisions and/or models based on the collected location information and/or forwards the collected prediction results and/or network self-optimization decisions and/or model results, and the model evaluation may be an evaluation of model accuracy and/or confidence, or an evaluation of whether the model needs to be retrained. In an implementation, if the evaluated model accuracy and/or confidence is low and/or below a certain threshold, a retraining process of the model is triggered.

FIG. 12B illustrates a schematic diagram of one aspect of a method of supporting location information collection according to embodiments of the present disclosure. Specifically, FIG. 12B shows a process in which a source node and/or a target node collect user location information. The source node transmits predicted UE trajectory information to the target node to provide reference information for the target node to determine subsequent mobile policies. In an implementation, the predicted UE trajectory information may be generated by an artificial intelligence machine learning model. The source node needs actual trajectory information of the UE to evaluate the made decisions and/or models. For example, the decisions may include trajectory prediction results and/or network self-optimization decisions and/or model results, etc., so the target node needs to transmit the actual trajectory information of the UE to the source node. The source node may use the collected actual trajectory information for model training and/or inference, and/or policy determination and/or updating, and/or configuration determination and/or updating, and/or decision determination and/or updating, etc. In some implementations, for example, the node may be a gNB or gNB-CU or gNB CU-CP or en-gNB or eNB or ng-eNB, and the last serving node may be a gNB or gNB-CU or gNB CU-CP or en-gNB or eNB or ng-eNB.

Step 1201B: the source node transmits location information collection configuration and/or location information reporting configuration to the target node, which is used to inform the target node of information of the location information collection configuration and/or location information reporting configuration. The location information reporting configuration may be the aforementioned second information. The location information collection configuration may be the aforementioned first information.

Step 1202B: the source node transmits a handover request to the target node, which may include one or more of the following: predicted UE trajectory information, location information reporting indication, location information reporting configuration and/or request, etc. The location information reporting indication and/or the location information reporting configuration and/or request are used to inform the target node that the location information of the UE needs to be collected and reported according to the configuration. The predicted UE trajectory information may be the aforementioned fourth information. The location information reporting indication may be the location information reporting indication in the second information. The location information reporting configuration and/or request may be the aforementioned second information.

Step 1203B: the target node transmits a handover request acknowledge to the source node.

Step 1204B: the target node and the UE perform a random access process.

Step 1205B: the UE performs a subsequent handover process at the target node.

Step 1206B: after the target node collects the user's location information, it transmits the location information to the source node. The location information may be the aforementioned fourth information. In an implementation, this step may be triggered by step 1202B, for example, step 1206B may be performed when the location information reporting indication is included in step 1202B, step 1206B may be performed when the predicted UE trajectory information is included in step 1202B, step 1206B may be performed when the location information reporting configuration and/or request is included in step 1202B. Or it may be a combination of the above situations, for example, step 1206B may be performed when one or more of the above information exists at the same time. The specific way for reporting may be determined by the location information reporting configuration and/or request received in step 1201B and/or step 1202B.

Step 1207B: the source node performs evaluation of the made decisions and/or models based on the collected location information and/or forwards the collected location information to other entities, etc. The decisions may include trajectory prediction results and/or network self-optimization decisions and/or model results, and the model evaluation may be an evaluation of model accuracy and/or confidence, or an evaluation of whether the model needs to be retrained. In an implementation, if the evaluated model accuracy and/or confidence is low and/or below a certain threshold, a retraining process of the model is triggered.

FIG. 12C illustrates a schematic diagram of one aspect of a method of supporting location information collection according to embodiments of the present disclosure. Specifically, FIG. 12C shows a process of exchanging location information between two entities, so as to provide location information of a second entity and/or an other entity to a first entity, so that the first entity can perform trajectory prediction and/or network self-optimization decision, etc. In some implementations, for example, the first entity may be a gNB or gNB-CU or gNB-DU or gNB CU-CP or gNB CU-UP or en-gNB or eNB or ng-eNB, and the second entity may be a UE. In other implementations, for example, the first entity may be a gNB or gNB-CU or gNB CU-CP or en-gNB or eNB or ng-eNB, and the second entity may be a gNB or gNB-CU or gNB-DU or gNB CU-CP or gNB CU-UP or en-gNB or eNB or ng-eNB. In yet other embodiments, for example, the first entity may be an AMF or SMF or MME, and the second entity may be a gNB or gNB-CU or gNB CU-CP or en-gNB or eNB or ng-eNB. In still other implementations, for example, the first entity may be a gNB or gNB-CU or gNB CU-CP or en-gNB or eNB or ng-eNB, and the second entity may be an AMF or SMF or MME.

Step 1201C: the first entity transmits location information collection configuration and/or location information reporting configuration to the second entity, which is used to inform the second entity of the configuration of location information collection and/or location information reporting. In an implementation, after the second entity receives the configuration, the second entity may not report the location information, but only save it as the configuration information. The reporting of location information may be triggered by the location information reporting request in step 1202C. The location information reporting configuration may be the aforementioned second information. The location information collection configuration may be the aforementioned first information.

Step 1202C: the first entity transmits a location information reporting request to the second entity, which is used to trigger the second entity to report the location information. The location information reporting request may be the aforementioned second information.

Step 1203C: the second entity collects and/or collates the location information of the second entity and/or other entities. In an implementation, for example, it may be the UE to collect and/or collate the location information of the UE, or it may be the other nodes to collect and/or collate the location information of the UE.

Step 1204C: the second entity reports the location information to the first entity. The reporting may be performed according to the configuration in step 1201C and/or the request in step 1202C. The location information may be the aforementioned fourth information.

Step 1205C: the first entity performs trajectory prediction and/or configuration updating and/or policy updating and/or network self-optimization decision setting based on the collected location information and/or forwards it to other entities, etc.

If the reporting configuration in step 1201C and/or the request information in step 1202C require the second entity to report periodically, steps 1203C and/or 1204C and/or 1205C may be performed periodically.

FIG. 12D illustrates a schematic diagram of one aspect of a method of supporting location information collection according to embodiments of the present disclosure. Specifically, FIG. 12D shows a process in which a source node and/or a target node collect user location information. The source node transmits predicted UE trajectory information to the target node to provide reference information for the target node to determine subsequent mobile policies. In an implementation, the predicted UE trajectory information may be generated by an artificial intelligence machine learning model. The source node needs actual trajectory information of the UE to evaluate the made decisions and/or models. For example, the decisions may include trajectory prediction results and/or network self-optimization decisions and/or model results, etc., so the target node needs to transmit the actual trajectory information of the UE to the source node. The source node may use the collected actual trajectory information for model training and/or inference, and/or policy determination and/or updating, and/or configuration determination and/or updating, and/or decision determination and/or updating, etc. In some implementations, for example, the node may be a gNB or gNB-CU or gNB CU-CP or en-gNB or eNB or ng-eNB, and the last serving node may be a gNB or gNB-CU or gNB CU-CP or en-gNB or eNB or ng-eNB.

Step 1201D: the source node transmits location information collection configuration and/or location information reporting configuration to the target node 1, which is used to inform the target node 1 of information of the location information collection configuration and/or location information reporting configuration. The location information reporting configuration may be the aforementioned second information. The location information collection configuration may be the aforementioned first information.

Step 1202D: the source node transmits a handover request to the target node 1, which may include one or more of the following: predicted UE trajectory information, location information reporting indication, location information reporting configuration and/or request, etc. The location information reporting indication and/or the location information reporting configuration and/or request are used to inform the target node 1 that the location information of the UE needs to be collected and reported according to the configuration. The predicted UE trajectory information may be the aforementioned fourth information. The location information reporting indication may be the location information reporting indication in the second information. The location information reporting configuration and/or request may be the aforementioned second information.

Step 1203D: the target node 1 transmits a handover request acknowledge to the source node.

Step 1204D: the target node 1 and the UE perform a random access process.

Step 1205D: the UE performs a subsequent handover process at the target node 1. The target node 1 transmits location information collection configuration and/or location information reporting configuration to the target node 2, which is used to inform the target node 2 of information of the location information collection configuration and/or location information reporting configuration. The location information reporting configuration may be the aforementioned second information. The location information collection configuration may be the aforementioned first information.

Step 1206D: the target node 1 transmits a handover request to the target node 2, which may include one or more of the following: predicted UE trajectory information, location information reporting indication, location information reporting configuration and/or request, etc. The location information reporting indication and/or the location information reporting configuration and/or request are used to inform the target node 2 that the location information of the UE needs to be collected and reported according to the configuration. The predicted UE trajectory information may be the aforementioned fourth information. The location information reporting indication may be the location information reporting indication in the second information. The location information reporting configuration and/or request may be the aforementioned second information.

Step 1208D: the target node 2 and the UE perform a random access process.

Step 1209D: after the target node 2 collects the location information of the user, it transmits the location information to the target node 1. The location information may be the aforementioned fourth information. In an implementation, this step may be triggered by step 1206D, for example, step 1209D may be performed when the location information reporting indication is included in step 1206D, step 1209D may be performed when the predicted UE trajectory information is included in step 1206D, step 1209D may be performed when the location information reporting configuration and/or request is included in step 1206D. Or it may be a combination of the above situations, for example, step 1209D may be performed when one or more of the above information exists at the same time. The specific way for reporting may be determined by the location information reporting configuration and/or request received in step 1205D and/or step 1206D.

Step 1210D: after the target node 1 collects the location information of the user, it transmits the location information to the source node. The location information may be the aforementioned fourth information. In an implementation, this step may be triggered by step 1202D, for example, step 1210D may be performed when the location information reporting indication is included in step 1202D, step 1210D may be performed when the predicted UE trajectory information is included in step 1202D, step 1210D may be performed when the location information reporting configuration and/or request is included in step 1202D. Or it may be a combination of the above situations, for example, step 1210D may be performed when one or more of the above information exists at the same time. The specific way for reporting may be determined by the location information reporting configuration and/or request received in step 1201D and/or step 1202D.

Step 1211D: the source node performs evaluation of the made decisions and/or models based on the collected location information and/or forwards the collected prediction results and/or network self-optimization decisions and/or model results, and the model evaluation may be an evaluation of model accuracy and/or confidence, or an evaluation of whether the model needs to be retrained. In an implementation, if the evaluated model accuracy and/or confidence is low and/or below a certain threshold, a retraining process of the model is triggered.

FIG. 12E illustrates a schematic diagram of one aspect of a method of supporting location information collection according to embodiments of the present disclosure. Specifically, FIG. 12E shows a process in which a source node and/or a target node collect user location information. The source node transmits predicted UE trajectory information to the target node to provide reference information for the target node to determine subsequent mobile policies. In an implementation, the predicted UE trajectory information may be generated by an artificial intelligence machine learning model. The source node needs actual trajectory information of the UE to evaluate the made decisions and/or models. For example, the decisions may include trajectory prediction results and/or network self-optimization decisions and/or model results, etc., so the target node needs to transmit the actual trajectory information of the UE to the source node. The source node may use the collected actual trajectory information for model training and/or inference, and/or policy determination and/or updating, and/or configuration determination and/or updating, and/or decision determination and/or updating, etc. In some implementations, for example, the node may be a gNB or gNB-CU or gNB CU-CP or en-gNB or eNB or ng-eNB, and the last serving node may be a gNB or gNB-CU or gNB CU-CP or en-gNB or eNB or ng-eNB.

Step 1201E: the source node transmits a handover request to the target node 1, which may include one or more of the following: predicted UE trajectory information, location information reporting configuration and/or request, location information collection configuration, etc. The predicted UE trajectory information may be the aforementioned fourth information. The location information reporting configuration and/or request may be the aforementioned second information. The location information collection configuration may be the aforementioned first information.

Step 1202E: the target node 1 transmits a handover request acknowledge to the source node.

Step 1203E: the target node 1 and the UE perform a random access process.

Step 1204E: the UE performs a subsequent handover process at the target node 1. The target node 1 transmits a handover request to the target node 2, which may include one or more of the following: predicted UE trajectory information, location information reporting configuration and/or request, location information collection configuration, etc. The predicted UE trajectory information may be the aforementioned fourth information. The location information reporting configuration and/or request may be the aforementioned second information. The location information collection configuration may be the aforementioned first information.

Step 1205E: the target node 2 transmits a handover request acknowledge to the target node 1.

Step 1206E: the target node 2 and the UE perform a random access process.

Step 1207E: after the target node 2 collects the location information of the user, it transmits the location information to the target node 1. The location information may be the aforementioned fourth information. In an implementation, this step may be triggered by step 1204E, for example, step 1207E may be performed when the location information reporting configuration and/or request is included in step 1204E, step 1207E may be performed when the predicted UE trajectory information is included in step 1204E, step 1207E may be performed when the location information collection configuration is included in step 1204E. Or it may be a combination of the above situations, for example, step 1207E may be performed when one or more of the above information exists in step 1204E at the same time.

Step 1208E: after the target node 1 collects the location information of the user, it transmits the location information to the source node. The location information may be the aforementioned fourth information. In an implementation, this step may be triggered by step 1201E, for example, step 1208E may be performed when the location information reporting configuration and/or request is included in step 1201E, step 1208E may be performed when the predicted UE trajectory information is included in step 1201E, step 1208E may be performed when the location information collection configuration is included in step 1201E. Or it may be a combination of the above situations, for example, step 1208E may be performed when one or more of the above information exists in step 1201E at the same time.

Step 1209E: the source node performs evaluation of the made decisions and/or models based on the collected location information and/or forwards the collected location information to other entities, etc. The decisions may include trajectory prediction results and/or network self-optimization decisions and/or model results, and the model evaluation may be an evaluation of model accuracy and/or confidence, or an evaluation of whether the model needs to be retrained. In an implementation, if the evaluated model accuracy and/or confidence is low and/or below a certain threshold, a retraining process of the model is triggered.

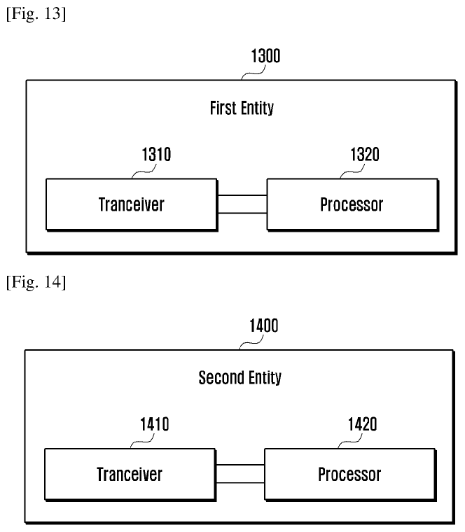

Next, FIG. 13 illustrates a schematic diagram of a first entity 1300 according to embodiments of the present disclosure.

As shown in FIG. 13, the first entity 1300 according to embodiments of the present disclosure may include a transceiver 1310 and a processor 1320. The transceiver 1310 may be configured to transmit and receive signals. The processor 1320 may be coupled to the transceiver 1310, and may be configured to (e.g., control the transceiver 1310 to) perform the methods performed by the first entity according to embodiments of the present disclosure.

FIG. 14 illustrates a schematic diagram of a second entity 1400 according to embodiments of the present disclosure.

As shown in FIG. 14, the second entity 1400 according to embodiments of the present disclosure may include a transceiver 1410 and a processor 1420. The transceiver 1410 may be configured to transmit and receive signals. The processor 1420 may be coupled to the transceiver 1410, and may be configured to (e.g., control the transceiver 1410 to) perform the methods performed by the second entity according to embodiments of the present disclosure. The processor may also be called a controller.

Embodiments of the present disclosure also provide a computer-readable medium having stored thereon computer-readable instructions which, when executed by a processor, implement any method according to embodiments of the present disclosure.

Various embodiments of the present disclosure may be implemented as computer-readable codes embodied on a computer-readable recording medium from a specific perspective. A computer-readable recording medium is any data storage device that can store data readable by a computer system. Examples of computer-readable recording media may include read-only memory (ROM), random access memory (RAM), compact disk read-only memory (CD-ROM), magnetic tape, floppy disk, optical data storage device, carrier wave (e.g., data transmission via the Internet), etc. Computer-readable recording media can be distributed by computer systems connected via a network, and thus computer-readable codes can be stored and executed in a distributed manner. Furthermore, functional programs, codes and code segments for implementing various embodiments of the present disclosure can be easily explained by those skilled in the art to which the embodiments of the present disclosure are applied.

It will be understood that the embodiments of the present disclosure may be implemented in the form of hardware, software, or a combination of hardware and software. The software may be stored as program instructions or computer-readable codes executable on a processor on a non-transitory computer-readable medium. Examples of non-transitory computer-readable recording media include magnetic storage media (such as ROM, floppy disk, hard disk, etc.) and optical recording media (such as CD-ROM, digital video disk (DVD), etc.). Non-transitory computer-readable recording media may also be distributed on computer systems coupled to a network, so that computer-readable codes are stored and executed in a distributed manner. The medium can be read by a computer, stored in a memory, and executed by a processor. Various embodiments may be implemented by a computer or a portable terminal including a controller and a memory, and the memory may be an example of a nontransitory computer-readable recording medium suitable for storing program(s) with instructions for implementing embodiments of the present disclosure. The present disclosure may be realized by a program with code for concretely implementing the apparatus and method described in the claims, which is stored in a machine (or computer)-readable storage medium. The program may be electronically carried on any medium, such as a communication signal transmitted via a wired or wireless connection, and the present disclosure suitably includes its equivalents.

What has been described above is only the specific implementation of the present disclosure, but the scope of protection of the present disclosure is not limited thereto. Anyone who is familiar with this technical field may make various changes or substitutions within the technical scope disclosed in the present disclosure, and these changes or substitutions should be covered within the scope of protection of the present disclosure. Therefore, the scope of protection of the present disclosure should be based on the scope of protection of the claims.

1-15. (canceled)

16. A method performed by a second node in a wireless communication system, the method comprising:
receiving, from a first node, a user equipment (UE) trajectory information collection and reporting configuration;
receiving, from the first node, a handover request message including a request for UE trajectory reporting;
collecting UE trajectory information based on the UE trajectory information collection and reporting configuration, and
transmitting, to the first node, information on a measured UE trajectory after a handover procedure for the UE is completed.

17. The method of claim 16, wherein the UE trajectory information collection and reporting configuration includes at least one of a reporting periodicity, a trajectory information collection duration, or a number of serving cells.

18. The method of claim 16, wherein collecting the UE trajectory information is performed before the UE accesses a cell.

19. The method of claim 16, wherein collecting the UE trajectory information is performed before a UE radio resource control (RRC) state is switched to an RRC idle state or an RRC inactive state.

20. The method of claim 16, wherein collecting the UE trajectory information is performed before the UE leaves a cell.

21. The method of claim 16, wherein collecting the UE trajectory information is performed based on a configured number of serving cells.

22. The method of claim 16, wherein the request for the UE trajectory reporting requests the second node to report the UE trajectory information after a handover based on the UE trajectory information collection and reporting configuration.

23. The method of claim 16, wherein transmitting information on the measured UE trajectory after the handover procedure is performed based on the UE trajectory information collection and reporting configuration.

24. The method of claim 16, wherein the information on the measured UE trajectory includes a cell identifier (ID) and a time of staying in a cell.

25. A second node in a wireless communication system, the second node comprising:
a transceiver configured to transmit and receive a signal; and
a processor coupled to the transceiver and configured to:
receive, from a first node, a user equipment (UE) trajectory information collection and reporting configuration,
receive, from the first node, a handover request message including a request for UE trajectory reporting,
collect UE trajectory information based on the UE trajectory information collection and reporting configuration, and
transmit, to the first node, information on a measured UE trajectory after a handover procedure for the UE is completed.

26. The second node of claim 25, wherein the UE trajectory information collection and reporting configuration includes at least one of a reporting periodicity, a trajectory information collection duration, or a number of serving cells.

27. The second node of claim 25, wherein the processor is further configured to collect the UE trajectory information before the UE accesses a cell.

28. The second node of claim 25,
wherein the processor is further configured to collect the UE trajectory information before a UE radio resource control (RRC) state is switched to an RRC idle state or an RRC inactive state.

29. The second node of claim 25, wherein the processor is further configured to collect the UE trajectory information before the UE leaves a cell.

30. The second node of claim 25, wherein the processor is further configured to collect the UE trajectory information based on a configured number of serving cells.

31. The second node of claim 25, wherein the request for the UE trajectory reporting requests the second node to report the UE trajectory information after a handover based on the UE trajectory information collection and reporting configuration.

32. The second node of claim 25, wherein the processor is further configured to transmit the information on the measured UE trajectory the after handover procedure is performed based on the UE trajectory information collection and reporting configuration.

33. The second node of claim 25, wherein the information on the measured UE trajectory includes a cell identifier (ID) and a time of staying in a cell.

34. A method performed by a first node in a wireless communication system, the method comprising:
transmitting, to a second node, a user equipment (UE) trajectory information collection and reporting configuration,
transmitting, to the second node, a handover request message including a request for UE trajectory reporting; and
receiving, from the second node, information on a measured UE trajectory after a handover procedure for the UE is completed.

35. The method of claim 34, wherein the UE trajectory information collection and reporting configuration includes at least one of a reporting periodicity, a trajectory information collection duration, or a number of serving cells.
